(19) United States
(12) Patent Application Publication
(10) Pub. No.: US 2009/0218881 A1
(43) Pub. Date: Sep. 3, 2009

(54) Fluid pressure control device

(75) Inventors: Hiroaki Aizawa, Anjo-city (JP); Takuya Hirano, Anjo-city (JP); Motoshi Suzuki, Nagoya-city (JP)

Correspondence Address: POSZ LAW GROUP, PLC, 12040 SOUTH LAKES DRIVE, SUITE 101, RESTON, VA, 20191, US

(73) Assignee: ADVICS CO., LTD., Kariya-city (JP)

(21) Appl. No.: 12/379,621

(22) Filed: Feb. 26, 2009

(30) Foreign Application Priority Data
Feb. 28, 2008 (JP) 2008-048363

(51) Int. Cl. B60T 8/34

(52) U.S. Cl. 303/113.5

(57) ABSTRACT

A brake force distribution control device which increases a brake force at an operation wheel so that a slip amount of the operation wheel becomes closer to a slip amount of a target wheel, wherein the slip amount of the target wheel is larger than the slip amount of the operation wheel.

### CROSS REFERENCE TO RELATED APPLICATION

This application is based on and incorporates herein by reference Japanese patent applications No. 2008-048363 filed on Feb. 28, 2008.

### FIELD OF THE INVENTION

The present invention relates to a brake force distribution device for controlling distribution of wheel braking forces to wheels of a vehicle so as to generate a large total braking force.

### BACKGROUND OF THE INVENTION

Conventionally, this kind of brake force distribution device is known as is described in Japanese patent application publication No. H06-16117. The brake force distribution device described in Japanese patent application publication No. H06-16117 detects the proportion of the wheel loads on the wheels of a vehicle by means of a vehicular acceleration sensor and thereby distributes brake forces to the wheels according to the proportion of the wheel loads. This operation is aimed for distributing wheel loads properly and thereby maximizing brake performance of the wheels with the attitude of the vehicle kept appropriate. The brake performance of a wheel means the utilization ratio of the friction coefficient μ between the wheel and a road (i.e. μ-utilization ratio). The μ-utilization ratio is described, for example, in Japanese application publication No. 2005-145256.

### SUMMARY OF THE INVENTION

However, the brake force distribution device described in Japanese patent application publication No. H06-16117 cannot estimate the proportion of the wheel loads when change occurs in how shipments are mounted to the vehicle. This prevents the brake force distribution device from maximizing the brake performance of the wheels. In other words, this prevents the wheels from generating as large brake forces as are capable. Therefore, the total brake force cannot achieve what the driver of the vehicle requires, and the stopping distance accordingly becomes longer.

It is therefore an object of the present invention to provide a brake force distribution control device which prevents the total brake force from becoming smaller and thereby prevents the stopping distance from being elongated even if the proportion of the wheel loads are not correctly estimated because of, for example, significant change in how shipments are mounted to the vehicle.

In view of the object, the inventors focused on a fact that a slip-related amount of a wheel is an amount indicating the wheel load on the wheel and found, based on the fact, a method in which the brake force is controlled based on the differences between slip-related amounts of the wheels. A slip-related amount of a wheel is an amount related to the slip of the wheel. This method is described with reference to FIG. 20.

FIG. 20 is a diagram showing relations between a slip ratio and a brake force for various values of a load on a wheel. Each of the lines 21-23 shows change in the brake force depending on the change of the slip ratio for a fixed value of the wheel load. The value of the wheel load increases in the direction shown by an arrow 20. As shown in FIG. 20, the braking force generated at the wheel reaches its peak when the slip ratio becomes 10 percents irrespective of the value of the wheel load. With a fixed brake force FX, the slip ratio of a wheel becomes smaller as the wheel load on the wheel becomes larger. Therefore, the slip ratio serves as a value indicating the wheel load on the wheel and the wheel load on the wheel is estimated according to the slip ratio. The slip ratio is an example of an amount indicating the slip-related amount and the wheel load on the wheel can be estimated even if another amount indicating the slip-related amount is used in place of the slip ratio.

If the brake force is distributed appropriately according to the proportion of the wheel loads, the slip-related amounts of the wheels become the same. Therefore, a deviation in the slip-related amounts means that the brake forces are distributed based on erroneous estimation of the wheel loads. Therefore, it is possible to maximize the efficiency in braking performance of the wheels if the brake force distribution control device controls the brake forces at the wheels based on the differences between the slip-related amounts of the wheels.

In an aspect of the present invention, a brake force distribution control device selects a first wheel and a second wheel, wherein the slip amount of the second wheel is larger than the slip amount of the first wheel. Then the brake force distribution control device increases a brake force at the first wheel so that a slip amount of the first wheel becomes closer to a slip amount of the second wheel. Thus, the brake force is increased at the first wheel generating an actual brake force smaller than a suitable brake force suitable for an actual wheel load on the first wheel so that the actual brake force becomes closer to the suitable brake force. As a result, the brake performance of each wheel is maximized.

The brake force distribution control device according to claim 1 may include: a load estimation section for estimating wheel loads based on an acceleration of a body of a vehicle which is detected by a vehicular acceleration sensing section, each of the wheel loads being applied between one of wheels of the vehicle and the ground; a target brake force calculation section for calculating target brake forces based on the estimated wheel loads, each of the target brake forces being a target value for a brake force at one of the wheels; an output section for outputting, in order to generate the target brake forces, a signal indicating the target brake forces to a brake force generation device for controlling the brake forces at the wheels individually; a slip-related amount calculating section for calculating slip-related amounts of the wheels based on wheel speeds of the wheels detected by a wheel speed sensing section, the slip-related amounts being related to slip amounts of the wheels; and a target brake force correction section for determining a most-slipping wheel having the largest slip-related amount of the wheels and further for increasing each calculated target brake force of at least one of the wheels so that each slip-related amount of said at least one of the wheels becomes closer to the largest slip-related amount, said at least one of the wheels being at least one of wheels other than the most-slipping wheel.

The brake force distribution control device may determine the most-slipping wheel having the largest slip-related amount and calculate the difference between the largest slip-related amount and each slip-related amount of a subject wheel, wherein the subject wheel is a wheel subject to correction. Then, the brake force distribution control device may increase the target brake force for the subject wheel based on the calculated difference.

Thus, the brake force distribution control device increases the brake force for the subject wheel so that the slip amount of the subject wheel comes closer to the slip amount of the most-slipping wheel at a degree of quickness corresponding to the difference between the slip amount for the most-slipping wheel and the slip amount for the subject wheel.

It is likely that the most-slipping wheel is the wheel achieving the best brake performance. In other words, it is likely that the most-slipping wheel is the wheel which achieves the highest μ-utilization ratio and generating the brake which is closest to the maximum capable brake force. Therefore, the brake performance for the wheels can be maximized if the brake force for the subject wheel having a slip-related amount smaller than the largest slip-related amount is corrected based on the difference between the largest slip-related amount and the slip-related amount of the subject wheel, so that the brake force of the subject wheel is increased.

For example, the target brake force correction section may increase one of the target brake forces corresponding to a subject wheel belonging to the wheels if a difference between the largest slip-related amount and the slip-related amount of the subject wheel is larger than a predetermined value, wherein the subject wheel is a wheel subject to correction.

The target brake force correction section may: determine a right most-slipping wheel having the largest slip-related amount of right side wheels of the vehicle; increase one of the target brake forces corresponding to a right subject wheel belonging to the right side wheels if a difference between the slip-related amount corresponding to the right most-slipping wheel and the slip-related amount of the subject wheel is larger than a predetermined value, wherein the right subject wheel is a wheel subject to correction; determine a left most-slipping wheel having the largest slip-related amount of left side wheels of the vehicle; and increase one of the target brake forces corresponding to a left subject wheel belonging to the left side wheels if a difference between the slip-related amount corresponding to the left most-slipping wheel and the slip-related amount of the subject wheel is larger than a predetermined value, wherein the left subject wheel is a wheel subject to correction.

As described above, wheels of the vehicle is divided into the two wheel groups, namely, the right wheel group and the left wheel group. The right wheel group includes the right side wheels, and the left wheel group includes the left side wheels. The brake force distribution control device then corrects a target brake force of a wheel in the right wheel group based on the relation of the slip-related amounts of the only wheels within the right wheel group and corrects a target brake force of a wheel in the left wheel group based on the relation of the slip-related amounts of the only wheels within the left wheel group. By separately correcting the target brake force for the right wheel group and the target brake force for the left wheel group, the brake forces generated at the wheels in a wheel group become suitable for conditions at a side of the vehicle where the wheel group is located. Therefore, it is possible to maximize the braking performance of each of the four wheels.

The target brake force correction section may: determine a front most-slipping wheel having the largest slip-related amount of front part wheels of the vehicle; increase one of the target brake forces corresponding to a front subject wheel belonging the front part wheels if a difference between the slip-related amount corresponding to the front most-slipping wheel and the slip-related amount of the subject wheel is larger than a predetermined value, wherein the front subject wheel is a wheel subject to correction; determine a rear most-slipping wheel having the largest slip-related amount of rear part wheels of the vehicle; and increase one of the target brake forces corresponding to a rear subject wheel belonging to the rear part wheels if a difference between the slip-related amount corresponding to the rear most-slipping wheel and the slip-related amount of the subject wheel is larger than a predetermined value, wherein the rear subject wheel is a wheel subject to correction.

As described above, wheels of the vehicle is divided into the two wheel groups, namely, the front wheel group and the rear wheel group. The front wheel group includes the front part wheels, and the rear wheel group includes the rear part wheels. The brake force distribution control device then corrects a target brake force of a wheel in the front wheel group based on the relation of the slip-related amounts of the only wheels within the front wheel group and corrects a target brake force of a wheel in the rear wheel group based on the relation of the slip-related amounts of the only wheels within the rear wheel group. By separately correcting the target brake force for the front wheel group and the target brake force for the rear wheel group, it is possible to maintain the proper relation between the brake forces generated at a front right wheel and a front left wheel and to maintain the proper relation between the brake forces generated at a rear right wheel and a rear left wheel Therefore, it is possible to maximize the braking performance of each of the wheels while keeping proper attitude of the vehicle.

The brake force distribution control device may correct, based on the slip-related amount, a quantity other than the target brake force, that is, an estimated wheel load which is used in calculating the target brake force. More specifically, the brake force distribution control device may include a load estimation correction section for determining a most-slipping wheel having the largest slip-related amount of the wheels and further for correcting each estimated wheel load on at least one of the wheels so as to increase each calculated target brake force of said at least one of the wheels so that each slip-related amount of said at least one of the wheels becomes closer to the largest slip-related amount, said at least one of the wheels being at least one of wheels other than the most-slipping wheel. With this operation, the brake force distribution control device can attain advantageous effect similar to those described above.

In this case, the brake force distribution control device may correct the estimated load in manners similar to those described above to attain advantageous effect similar to those described above.

The brake force distribution control device may correct, based on the slip-related amount, a quantity other than the target brake force, that is, vehicle characteristics which is used in estimating the wheel loads. More specifically, the brake force distribution control device may include a vehicular characteristics correction section for determining a most-slipping wheel having the largest slip-related amount of the wheels and further for correcting each vehicular characteristic used to estimate each estimated wheel load on at least one of the wheels so as to increase each calculated target brake force of said at least one of the wheels so that each slip-related amount of said at least one of the wheels becomes closer to the largest slip-related amount, said at least one of the wheels being at least one of wheels other than the most-slipping wheel. With this operation, the brake force distribution control device can attain advantageous effect similar to those described above.

In this case, the brake force distribution control device may correct the estimated load in manners similar to those described above to attain advantageous effect similar to those described above.

### BRIEF DESCRIPTION OF THE DRAWINGS

The invention, together with additional objective, features and advantages thereof, will be best understood from the following description, the appended claims and the accompanying drawings. In the drawings:

FIG. 1 is a block diagram showing a brake force distribution control device for a vehicle according to a first embodiment of the present invention;

FIG. 2 is a graph showing a relation between an M/C pressure and a target deceleration;

FIG. 3 is a flowchart showing a target brake force correction process for wheels executed by a target brake force correction section for the wheels;

FIG. 4 is a flowchart showing a target brake force correction process for wheels executed by a target brake force correction section for the wheels in a brake force distribution control device according to a second embodiment of the present invention;

FIG. 5 is a flowchart showing a target brake force correction process for wheels executed by a target brake force correction section for the wheels in a brake force distribution control device according to a third embodiment of the present invention;

FIG. 6 is a flowchart showing a target brake force correction process for wheels executed by a target brake force correction section for the wheels in a brake force distribution control device according to a fourth embodiment of the present invention;

FIG. 7 is a flowchart showing a target brake force correction process for wheels executed by a target brake force correction section for the wheels in a brake force distribution control device according to a fifth embodiment of the present invention;

FIG. 8 is a block diagram showing a brake force distribution control device for a vehicle according to a sixth embodiment of the present invention;

FIG. 9 is a flowchart showing a load estimation correction process executed by a load estimation correction section;

FIG. 10 is a flowchart showing a load estimation correction process executed by a load estimation correction section in a brake force distribution control device according to a seventh embodiment of the present invention;

FIG. 11 is a flowchart showing a load estimation correction process executed by a load estimation correction section in a brake force distribution control device according to an eighth embodiment of the present invention;

FIG. 12 is a flowchart showing a load estimation correction process executed by a load estimation correction section in a brake force distribution control device according to a ninth embodiment of the present invention;

FIG. 13 is a flowchart showing a load estimation correction process executed by a load estimation correction section in a brake force distribution control device according to a tenth embodiment of the present invention;

FIG. 14 is a block diagram showing a brake force distribution control device for a vehicle according to an eleventh embodiment of the present invention;

FIG. 15 is a flowchart showing a vehicular characteristics correction process executed by a vehicular characteristics correction section;

FIG. 16 is a flowchart showing a vehicular characteristics correction process executed by a vehicular characteristics correction section in a brake force distribution control device according to a twelfth embodiment of the present invention;

FIG. 17 is a flowchart showing a vehicular characteristics correction process executed by a vehicular characteristics correction section in a brake force distribution control device according to a thirteenth embodiment of the present invention;

FIG. 18 is a flowchart showing a vehicular characteristics correction process executed by a vehicular characteristics correction section in a brake force distribution control device according to a fourteenth embodiment of the present invention;

FIG. 19 is a flowchart showing a vehicular characteristics correction process executed by a vehicular characteristics correction section in a brake force distribution control device according to a fifteenth embodiment of the present invention; and

FIG. 20 is a diagram showing relations between a slip ratio and a brake force for various loads on a wheel.

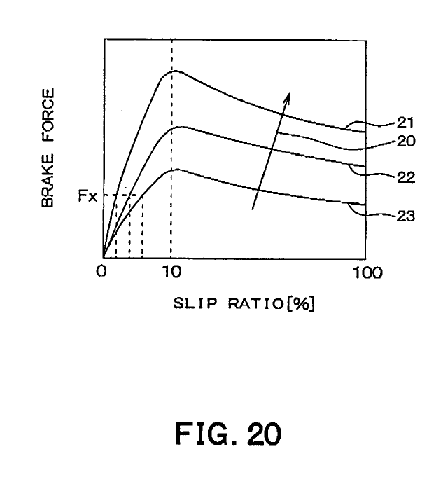

### DETAILED DESCRIPTION OF THE EMBODIMENTS

Hereinafter, embodiments of the present invention are described with reference to the above figures. Note that elements that are the same or equivalent to each other in the following embodiments are denoted with the same reference numeral in the appended drawings.

### First Embodiment

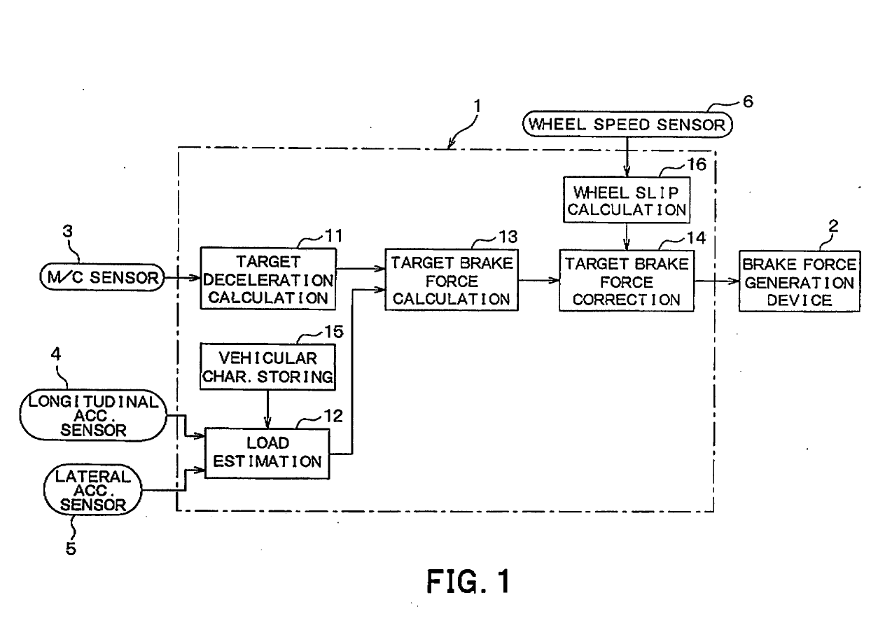

Hereinafter, a first embodiment is described. FIG. 1 is a block diagram showing a brake force distribution control device 1 for a vehicle according to the present invention. Components of the brake force distribution control device 1 are described with reference to FIG. 1.

The brake force distribution control device 1 according to the present embodiment calculates target brake forces respectively for the wheels of the vehicle based on quantities detected by several sensors. Then the brake force distribution control device 1 corrects the target brake forces and transmits the corrected target brake forces to a brake force generation device 2 for the wheels. The brake force distribution control device 1 thereby causes brake force generation device 2 to generate actual brake forces respectively at the wheels of the vehicle so that the actual brake forces match the corrected target brake forces. An electric control unit (hereinafter referred to as an ECU) for use in braking is an example of the brake force distribution control device 1. The brake force generation device 2 can be any one of well-known devices for generating a brake force such as a brake device using air pressure and a regeneration brake system using a motor. Therefore, the details of the brake force generation device 2 are not described here.

As shown in FIG. 1, the brake force distribution control device 1 includes a target deceleration calculation section 11, a load estimation section 12, a target brake force calculation section 13 for the wheels, and a target brake force correction section 14 for the wheels.

The target deceleration calculation section 11 calculates a target deceleration which depends on an amount of driver's operation on a brake operation member (not illustrated) such as a brake pedal and a brake lever. The target deceleration is a target value for the deceleration of the vehicle. More specifically, the target deceleration calculation section 11 receives a detection signal from a master cylinder pressure sensor 3 for detecting a brake fluid pressure in a master cylinder (not illustrated) and calculates the target deceleration based on the detection signal from the master cylinder pressure sensor 3. Hereinafter, the master cylinder is referred to as an M/C and the brake fluid pressure in the M/C is referred to as an M/C pressure.

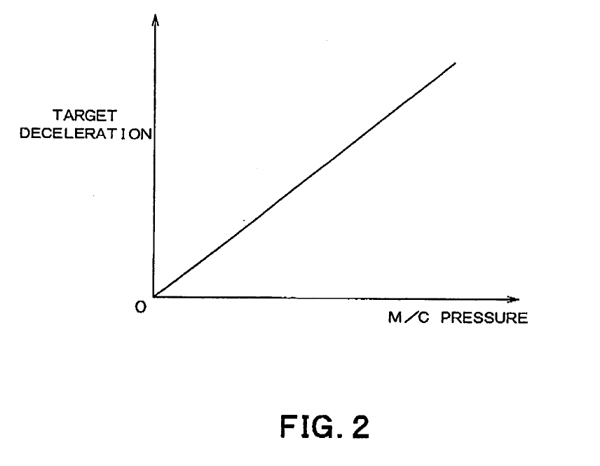

FIG. 2 is a graph showing an example of the relation between the M/C pressure and the target deceleration. As shown in FIG. 2, the target deceleration becomes larger as the M/C pressure becomes larger. A characteristic map or a mathematical function is stored in the target deceleration calculation section 11, and the target deceleration calculation section 11 calculates the target deceleration corresponding to the detected M/C pressure based on the characteristic map or the mathematical function.

In the above example, the amount of operation on the brake operation member is detected based on the detection signal from the M/C pressure sensor 3. However, the amount of operation on the brake operation member may be detected based on a detection signal from a pedaling force sensor (not illustrated) or a stroke sensor (not illustrated). In addition, the amount of operation on the brake operation member may be detected based on two or more of these sensors. Furthermore, the amount of operation on the brake operation member may be detected based on a quantity outputted by other control device if the quantity indicates the deceleration of the vehicle.

The load estimation section 12 estimates a wheel load on each of the wheels. A wheel load on a wheel is a load applied from the ground to the wheel and is also referred to simply as a load. More specifically, the load estimation section 12 obtains a detection signal from a longitudinal acceleration sensor 4, a detection signal from a lateral acceleration sensor 5, and characteristics of the vehicle stored in a vehicular characteristics storing section 15 and then estimates the loads based on the obtained quantities. For example, an estimation of a load on a front right wheel W_{FR} is expressed as follows:

W_{FR}=WF_{RO}+ΔW_{GX}/2+ΔW_{GY}, (1)

where ΔW_{GX} and ΔW_{GY} denote, respectively, load shifts in the longitudinal direction and in the lateral direction and are expressed as follows:

ΔW_{GX}=M·G_{X}·H/L, (2)

ΔW_{GY}=(W_{FO})·M·G_{Y}·H/b, (3)

where M denotes the weight of the body of the vehicle, H denotes the height of center of gravity of the vehicle, L denotes the wheelbase, b denotes the track of the vehicle, G_{X} denotes the longitudinal acceleration, and G_{Y} denotes the lateral acceleration. In addition, W_{FRO} denotes the wheel load on the front right wheel in the case that the vehicle is standing still. In other words, W_{FRO} denotes an initial wheel load on the front right wheel. Furthermore, W_{FO} denotes an axial load on both of the front wheels in the case that the vehicle is standing still. In other words, W_{FO} denotes an initial axial load on the front wheels. The vehicle body weight M, the height of center of gravity H, the wheelbase L, the track b, the initial wheel load W_{FRO} on the front right wheel, and the initial axial load W_{FO} on the front wheels belong to the characteristics of the vehicle and are stored. On the other hand, the longitudinal acceleration G_{X} and the lateral acceleration G_{Y} are calculated based on the detection signals from longitudinal acceleration sensor 4 and the lateral acceleration sensor 5.

Thus, the wheel load W_{FR} put on the front right wheel can be calculated. The wheel loads put on the other wheels can be calculated in any of well-known methods such as a method which is similar to one used for the front right wheel.

In the present embodiment, the vehicular characteristics storing section 15 is installed to the brake force distribution control device 1 and stores the values of the vehicular characteristics. However, the vehicular characteristics storing section 15 may obtain the values of the vehicular characteristics from other ECU located in the vehicle if the ECU stores the values of the characteristics of the vehicle.

In the present embodiment, the detection signals from the longitudinal acceleration sensor 4 and the lateral acceleration sensor 5 are used in order to obtain the longitudinal acceleration G_{X} and the lateral acceleration G_{Y}. However, the longitudinal acceleration G_{X} and the lateral acceleration G_{Y} can be obtained based on any quantity other than the detection signals from the longitudinal acceleration sensor 4 or the lateral acceleration sensor 5. For example, the longitudinal acceleration G_{X} and the lateral acceleration G_{Y} can be obtained based on the speeds of the wheels and the steering angle of the vehicle.

The target brake force calculation section 13 calculates basic target brake forces respectively for the wheels based on the target deceleration so that the target brake forces are distributed proportional to the estimated loads calculated by the load estimation section 12 respectively for the wheels.

The target brake force correction section 14 gives corrections to the basic target brake forces calculated by the target brake force calculation section 13 and outputs an indication signal for causing the brake force generation device 2 to generate corrected target brake forces respectively at the wheels. The indication signal may be a signal indicating a value of hydraulic pressure if the brake force generation device 2 is a hydraulic brake device. In addition, the indication signal may be a signal indicating an amount of electric current if the brake force generation device 2 is an electrically driven brake device.

The brake force distribution control device 1 also includes a wheel slip calculation section 16 which receives a detection signal from a wheel speed sensor 6 for detecting speeds of the respective wheels and calculates slip amounts of the respective wheels. A slip amount of a wheel is obtained by the following equation:

(the slip amount)=|(the speed of the body of the vehicle)−(the speed of the wheel)|/(the speed of the body of the vehicle).

The wheel slip calculation section 16 outputs the calculated slip amounts to the target brake force correction section 14. Accordingly, the target brake force correction section 14 corrects the basic target brake forces based on the outputted slip amounts. Details on the correction based on the slip amounts are described later. As is described, the slip amounts of the all wheels become the same if the brake forces are distributed properly according to the proportion of the loads on the wheels. Therefore, a deviation in the slip amounts means that the brake forces are distributed based on erroneous estimation of the loads on the wheels. In this case, it is possible to maximize braking capability of each of the wheels if the target brake force correction section 14 corrects the brake forces for the wheels by correcting the basic target brake forces based on the deviation among the slip amounts of the wheels.

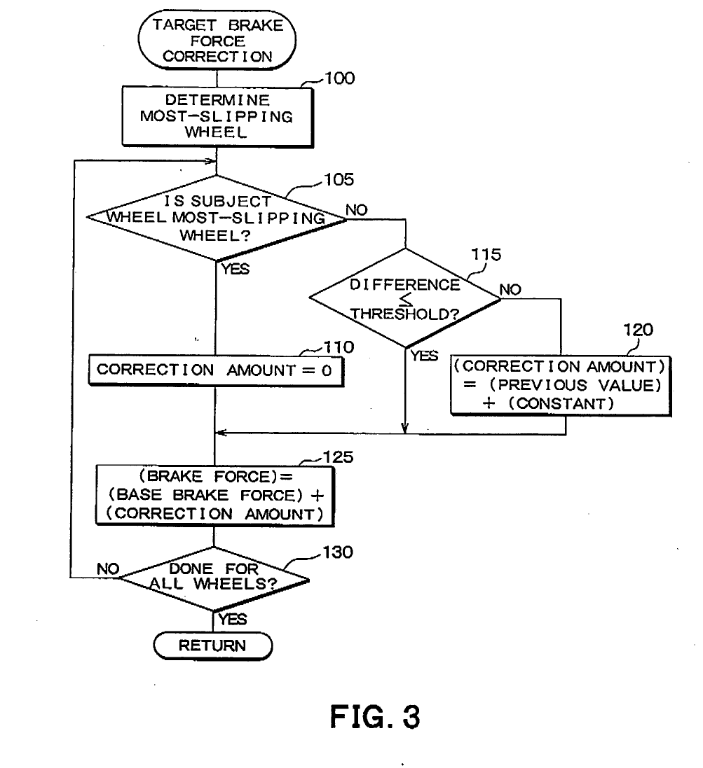

Hereinafter, operation of the brake force distribution control device 1 having the above configuration is described. The target deceleration calculation section 11 merely calculates the target decelerations repeatedly every control period in the method already described above, and the load estimation section 12 merely estimates the loads on the wheels repeatedly every control period in the method already described above. Therefore, the method of correction of the basic target brake forces at the target brake force correction section 14 is described in detail since the correction is a unique part of the present embodiment. FIG. 3 is a flowchart showing a target brake force correction process for the wheels executed by the target brake force correction section 14. Based on a program stored in advance, the target brake force correction section 14 executes the target brake force correction process shown in FIG. 3 for the wheels at intervals of a predetermined control-cycle period.

On starting the target brake force correction process, the target brake force correction section 14 (hereinafter also referred to as a correction section 14) determines at step 100 a most-slipping wheel. The determination is performed by selecting the wheel which has the largest slip amount among all of the wheels. A slip amount of a wheel is calculated based on the difference between the speed of this wheel and the speed of the body (or, chassis) of the vehicle, wherein the speed of the body of the vehicle may be calculated based on the speeds of the wheels by means of any well-known method.

Then, the correction section 14 proceeds to step 105 to determine whether or not a subject wheel is the most-slipping wheel. The subject wheel is one of the wheels which is currently subject to correction of the target brake force correction process. If the subject wheel is the most-slipping wheel having the largest slip amount, the correction section 14 proceeds to step 110 to set a target brake force correction amount to zero and then proceeds to step 125. As is described, a brake force of a wheel reaches its maximum when the slip ratio of this wheel becomes approximately 10 percent. Therefore, the most-slipping wheel is the wheel which achieves the best brake efficiency of all of the wheels unless a stability control such as an anti-skid control (hereinafter referred to as an ABS control) and an electric stability control (hereinafter referred to as an ESC control) is in operation. The stability control is a control in which brake forces are adjusted in order to stabilize the vehicle. Therefore, there is no need for correcting the basic target brake force for the most-slipping wheel and the target brake force correction amount is accordingly set to zero.

If the determination at step 105 is negative, the correction section 14 proceeds to step 115 to determine whether or not a slip difference is equal to or smaller than a predetermined value (i.e. a threshold), wherein the slip difference is the difference between the slip amounts of the most-slipping wheel and the subject wheel. If the determination at step 115 is affirmative, the correction section 14 proceeds to step 125 in order to leave the target brake force correction amount for the subject wheel unchanged from that in the previous control cycle. If the determination at step 115 is negative, the correction section 14 proceeds to step 120 to give modification to the target brake force correction amount for the subject wheel.

At step 120, the correction section 14 calculates a current target brake force correction amount (i.e. a target brake force amount at the present control cycle) for the subject wheel. The current target brake force correction amount for the subject wheel is obtained by adding a constant increase amount to the target brake force correction amount for the subject wheel in the previous control cycle, as follows:

(the current target brake force correction amount)=(the target brake force correction amount in the previous control cycle)+(the constant increase amount) (4)

Then, the correction section 14 proceeds to step 125 to obtain the corrected target brake force for the subject wheel by adding the current target brake force correction amount for the subject wheel to the basic target brake force for the subject wheel, as follows:

(the corrected target brake force)=(basic target brake force)+(the current target brake force correction amount) (5)

Then, the correction section 14 proceeds to step 130 to determine whether or not step 105 and following steps have been executed for all of the wheels in the present control cycle. If the determination at step 130 is affirmative, the correction section 14 terminates the present control cycle. If the determination at step 130 is negative, the correction section 14 proceeds to step 105 again in order to execute step 105 and following steps for a wheel which has not become the subject wheel in the present control cycle.

As described above, the brake force distribution control device 1 according to the present embodiment determines the most-slipping wheel having the largest slip amount of all of the wheels, then calculates a difference between the slip amount for the most-slipping wheel and the slip amount for the subject wheel, and then determines the target brake force correction amount for the subject wheel based on the calculated difference. More specifically, the brake force distribution control device 1 increases the target brake force correction amount for the subject wheel by adding the constant increase amount to the target brake force correction amount for the subject wheel in the previous control cycle if the calculated difference is larger than the predetermined value. If the calculated difference is not larger than the predetermined value, the brake force distribution control device 1 uses the target brake force correction amount as it was in the previous control cycle. Thus, the brake force distribution control device 1 increases the brake force for the subject wheel so that the slip amount of the subject wheel comes closer to the slip amount of the most-slipping wheel at a degree of quickness corresponding to the difference between the slip amount for the most-slipping wheel and the slip amount for the subject wheel.

As described above, the slip amounts of the wheels become the same if the brake forces are distributed properly according to the proportion of the loads on the wheels. Therefore, a deviation in the slip amounts means that the brake forces are distributed based on erroneous estimation of the load on the wheels. In this case, it is likely that the most-slipping wheel can achieve most efficient braking performance. Therefore, it is possible to maximize the efficiency in braking performance of the wheels if the brake force distribution control device 1 selects one or more of the wheels having the slip amount smaller than that of the most-slipping wheel, corrects the brake force to be generated at each selected wheel based on the difference between the slip amount for each selected wheel and the slip amount for the most-slipping wheel, and thereby increases the brake force for each selected wheel. Therefore, it is possible to prevent the brake forces from being suppressed and accordingly prevent the stopping distance from becoming longer even if the proportion of the loads distributed on the wheels is not estimated correctly because of, for example, significant change in how shipments are mounted to the vehicle.

In Japanese Patent Application Publication No. H09-86375, a brake device is described which increases a brake force at a rear wheel after an ABS control is started. However, the brake force of the rear wheel is not increased until the ABS control is started. Therefore, the deceleration of the vehicle is suppressed. In contrast, the brake force distribution control device 1 according to the present embodiment can generate a sufficient brake force irrespective of the absence or existence of the ABS control since the brake force distribution control device 1 determines, irrespective of whether or not the ABS control or the like is in operation, the brake force correction amount of the subject wheel based on the difference between the slip amounts of the most-slipping wheel and the subject wheel.

However, it should be noted that the correction performed by the correction section 14 may cause unintended effect if the correction is performed while the ABS control or the ESC control is in operation. The unintended effect may put negative influence on the behavior of the vehicle when the ABS control or the ESC control is terminated and distribution of the brake forces are executed based on the normal wheel loads on the wheels. Therefore, the correction may be prohibited while the ABS control or the ESC control is in operation. In this case, the brake force distribution control device 1 still determines, even in the absence of the ABS control, the brake force correction amount of the subject wheel based on the difference between the slip amounts of the most-slipping wheel and the subject wheel.

In Japanese Patent Application Publication No. H08-198076, a method is described in which the brake force of a wheel having a relatively larger slip ratio is decreased so as to stabilize the attitude of the vehicle. However, this method suppresses a total brake force of the vehicle since a brake force of a wheel is decreased so that it becomes closer to the brake force of the wheel with the lowest braking efficiency. In contrast, the brake force distribution control device 1 according to the present embodiment can generate a large total brake force because the brake force distribution control device 1 increases a brake force of a wheel so that the slip amount of the wheel becomes closer to the slip amount of most-slipping wheel.

### Second Embodiment

Hereinafter, a second embodiment of the present invention is described. In the present embodiment, following modification is given to the first embodiment. In the modification, the wheels of the vehicle are divided into two wheel groups, namely, a right wheel group and a left wheel group. The right wheel group includes the two right side wheels, and the left wheel group includes the two left side wheels. In the target brake force correction process in the present embodiment, the slip amount of a wheel is compared only with the slip amount of the other wheel in the same wheel group. The target brake force correction amount for a wheel is therefore determined based not on the relation with the wheels in the different wheel group but on the relation with the other wheel in the same wheel group. It should be noted that a basic configuration of the brake force distribution control device 1 according to the present embodiment is identical with that of the first embodiment. The only difference between the first embodiment and the present embodiment is the target brake force correction process executed by target brake force correction section 14. Therefore, the target brake force correction process is described.

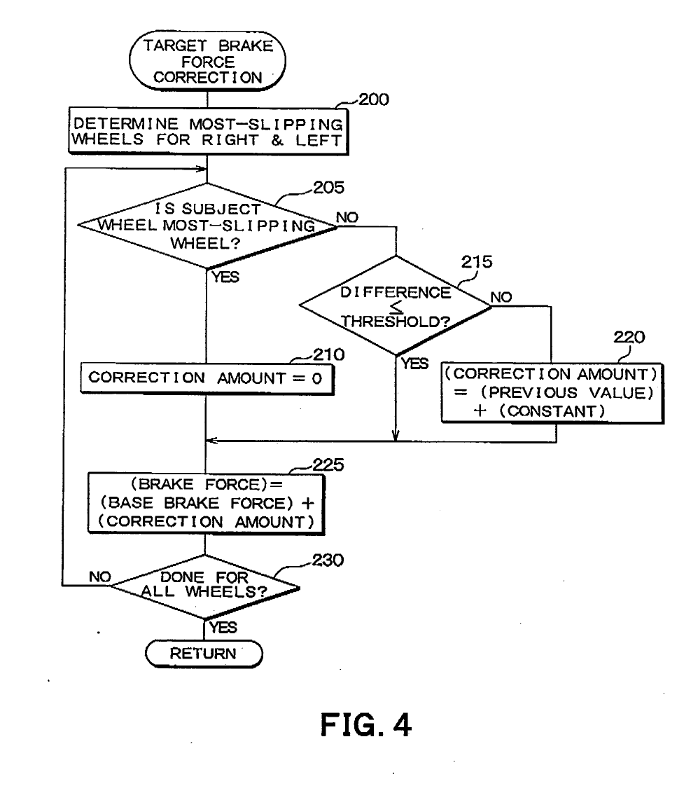

FIG. 4 is a flowchart showing a target brake force correction process for the wheels executed by the target brake force correction section 14 of the brake force distribution control device 1 according to the present embodiment. Based on a program stored in advance, the target brake force correction section 14 executes the target brake force correction process shown in FIG. 4 for the wheels at intervals of a predetermined control period.

On starting the target brake force correction process, the target brake force correction section 14 determines at step 200 a most-slipping wheel within each of the right wheel group and the left wheel group. The process in step 200 is executed by applying the method used in step 100 in FIG. 3 to each of the right wheel group and the left wheel group. More specifically, the correction section 14 selects the wheel having the larger slip amount in the right wheel group and the wheel having the larger slip amount in the left wheel group.

Then, the correction section 14 proceeds to step 205 to determine whether or not the subject wheel is the most-slipping wheel in a subject wheel group. The subject wheel group is the wheel group to which the subject wheel belongs. Therefore, the subject wheel group is the right wheel group if the subject wheel is one of the front right wheel and the rear right wheel, and the subject wheel group is the left wheel group if the subject wheel is one of the front left wheel and the rear left wheel. If the determination at step 205 is affirmative, the correction section 14 proceeds to step 210 to set the target brake force correction amount to zero and then proceeds to step 225.

If the determination at step 205 is negative, the correction section 14 proceeds to step 215 to determine whether or not a slip difference is equal to or smaller than a predetermined value (i.e. a threshold), wherein the slip difference is the difference between the slip amounts of the most-slipping wheel in the subject wheel group and the subject wheel. If the determination at step 215 is affirmative, the correction section 14 proceeds to step 225 in order to leave the target brake force correction amount for the subject wheel unchanged from that in the previous control cycle. If the determination at step 215 is negative, the correction section 14 proceeds to step 220 to give modification to the target brake force correction amount for the subject wheel.

At step 220, the correction section 14 calculates the target brake force correction amount for the subject wheel in the same manner as step 120. Then the correction section 14 proceeds to step 225 to calculate the corrected target brake force for the subject wheel in the same manner as step 125. Then, the correction section 14 proceeds to step 230 to determine whether or not step 205 and following steps have been executed for all of the wheels in the present control cycle. The correction section 14 repeats step 205 and following steps until the determination at step 230 becomes affirmative and terminates the target brake force correction process in the present control cycle when the determination at step 230 becomes affirmative.

As described above, the wheels of the vehicle is divided into the two wheel groups, namely, the right wheel group and the left wheel group. The right wheel group includes the two right side wheels, and the left wheel group includes the two left side wheels. In the target brake force correction process in the present embodiment, the brake force distribution control device 1 selects one of the four wheels one by one as the subject wheel, compares the slip amount of the subject wheel only with the slip amount of the other wheel in the wheel group to which the subject wheel belongs, and determines the target brake force correction amounts based not on the relation with the wheels in the wheel group to which the subject wheel does not belong but on the relation with the other wheel in the wheel group to which the subject wheel belongs to. By separately determining the target brake force correction amounts for the right wheel group and the target brake force correction amounts for the left wheel group, the brake forces generated at the wheels in a wheel group become suitable for conditions at a side of the vehicle where the wheel group is located. Therefore, it is possible to maximize the braking performance of each of the four wheels while keeping proper attitude of the vehicle. In addition, it is possible to prevent the brake forces from being suppressed and accordingly prevent the stopping distance from becoming longer even if the proportion of the wheel loads distributed on the wheels is not estimated correctly because of, for example, significant change in how shipments are mounted to the vehicle.

### Third Embodiment

Hereinafter, a third embodiment of the present invention is described. In the present embodiment, following modification is given to the first embodiment. In the modification, the wheels of the vehicle are divided into two wheel groups, namely, a front wheel group and a rear wheel group. The front wheel group includes the two front part wheels, and the rear wheel group includes the two rear part wheels. In the target brake force correction process in the present embodiment, the slip amount of a wheel is compared only with the slip amount of the other wheel in the same wheel group. The target brake force correction amount for a wheel is therefore determined based not on the relation with the wheels in the different wheel group but on the relation with other wheel in the same wheel group. It should be noted that a basic configuration of the brake force distribution control device 1 according to the present embodiment is identical with that of the first embodiment. The only difference between the first embodiment and the present embodiment is the target brake force correction process executed by target brake force correction section 14. Therefore, the target brake force correction process is described.

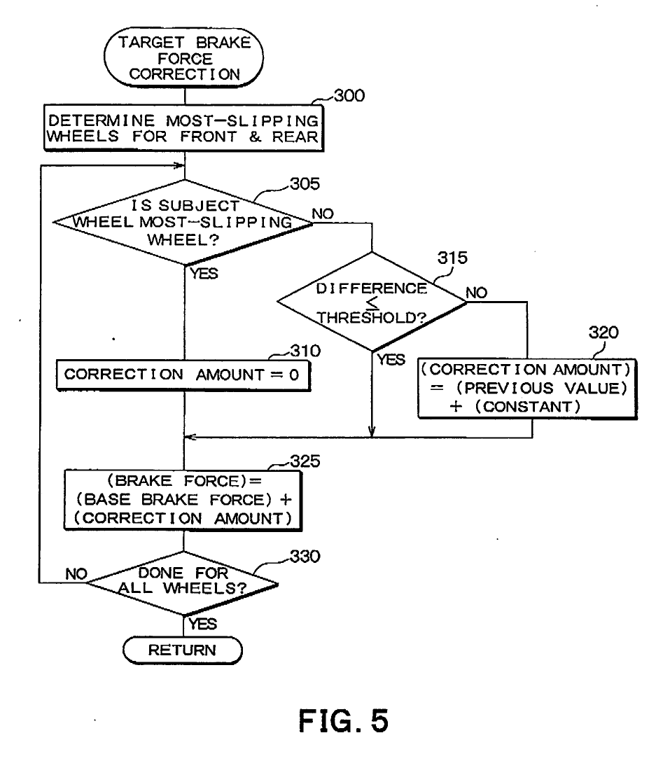

FIG. 5 is a flowchart showing a target brake force correction process for the wheels executed by the target brake force correction section 14 of the brake force distribution control device 1 according to the present embodiment. Based on a program stored in advance, the target brake force correction section 14 executes the target brake force correction process shown in FIG. 5 for the wheels at intervals of a predetermined control period.

On starting the target brake force correction process, the target brake force correction section 14 determines at step 300 a most-slipping wheel for each of the front wheel group and the rear wheel group. The process in step 300 is executed by applying the method used in step 100 in FIG. 3 to each of the front wheel group and the rear wheel group. More specifically, the correction section 14 selects the wheel having the larger slip amount in the front wheel group and the wheel having the larger slip amount in the rear wheel group.

Then, the correction section 14 proceeds to step 305 to determine whether or not the subject wheel is the most-slipping wheel in a subject wheel group. The subject wheel group is the wheel group to which the subject wheel belongs. Therefore, the subject wheel group is the front wheel group if the subject wheel is one of the front right wheel and the front left wheel, and the subject wheel group is the rear wheel group if the subject wheel is one of the rear right wheel and the rear left wheel. If the determination at step 305 is affirmative, the correction section 14 proceeds to step 310 to set the target brake force correction amount to zero and then proceeds to step 325.

If the determination at step 305 is negative, the correction section 14 proceeds to step 315 to determine whether or not a slip difference is equal to or smaller than a predetermined value (i.e. a threshold), wherein the slip difference is the difference between the slip amounts of the most-slipping wheel in the subject wheel group and the subject wheel. If the determination at step 315 is affirmative, the correction section 14 proceeds to step 325 in order to leave the target brake force correction amount for the subject wheel unchanged from that in the previous control cycle. If the determination at step 315 is negative, the correction section 14 proceeds to step 320 to give modification to the target brake force correction amount for the subject wheel.

At step 320, the correction section 14 calculates the target brake force correction amount for the subject wheel in the same manner as step 120. Then the correction section 14 proceeds to step 325 to calculate the corrected target brake force for the subject wheel in the same manner as step 325. Then, the correction section 14 proceeds to step 330 to determine whether or not step 305 and following steps have been executed for all of the wheels in the present control cycle. The correction section 14 repeats step 305 and following steps until the determination at step 330 becomes affirmative and terminates the target brake force correction process in the present control cycle when the determination at step 330 becomes affirmative.

As described above, the wheels of the vehicle is divided into the two wheel groups, namely, the front wheel group and the rear wheel group. The front wheel group includes the two front part wheels, and the rear wheel group includes the two rear part wheels. In the target brake force correction process in the present embodiment, the brake force distribution control device 1 selects one of the four wheels one by one as the subject wheel, compares the slip amount of the subject wheel only with the slip amount of the other wheel in the wheel group to which the subject wheel belongs, and determines the target brake force correction amounts based not on the relation with the wheels in the wheel group to which the subject wheel does not belong but on the relation with the other wheel in the wheel group to which the subject wheel belongs to. By separately determining the target brake force correction amounts for the front wheel group and the target brake force correction amounts for the rear wheel group, it is possible to properly control the brake forces generated at the front wheels and the rear wheels. Therefore, it is possible to maximize the braking performance of each of the four wheels while keeping proper attitude of the vehicle. In addition, it is possible to prevent the brake forces from being suppressed and accordingly prevent the stopping distance from becoming longer even if the proportion of the wheel loads distributed on the wheels is not estimated correctly because of, for example, significant change in how shipments are mounted to the vehicle.

### Fourth Embodiment

Hereinafter, a fourth embodiment of the present invention is described. In the present embodiment, following modification is given to the first embodiment. In the modification, a reference slip amount for the front part wheels and a reference slip amount for the rear part wheels are determined. In addition, in the target brake force correction process, the correction amounts to be applied to the target brake forces for the front right wheel and the front left wheel are set to a common value, and the correction amounts to be applied to the target brake forces for the rear right wheel and the rear left wheel are set to a common value. It should be noted that a basic configuration of the brake -force distribution control device 1 according to the present embodiment is identical with that of the first embodiment. The only difference between the first embodiment and the present embodiment is the target brake force correction process executed by target brake force correction section 14. Therefore, the target brake force correction process is described.

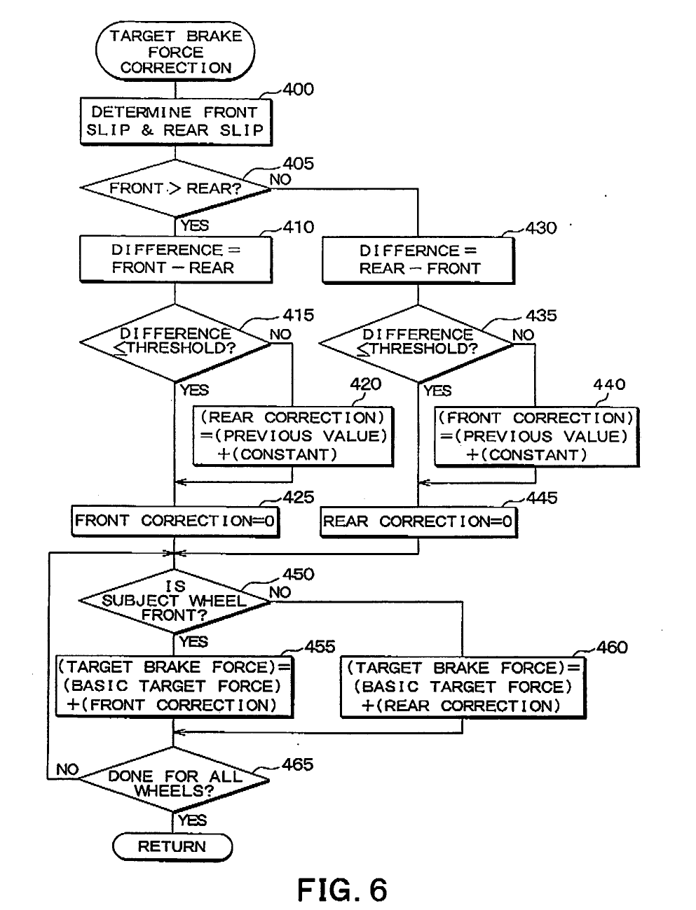

FIG. 6 is a flowchart showing a target brake force correction process for the wheels executed by the target brake force correction section 14 of the brake force distribution control device 1 according to the present embodiment. Based on a program stored in advance, the target brake force correction section 14 executes the target brake force correction process shown in FIG. 6 for the wheels at intervals of a predetermined control period.

On starting the target brake force correction process, the target brake force correction section 14 determines at step 400 a reference front wheel slip amount and a reference rear wheel slip amount. The reference front wheel slip amount is a reference slip amount representing the states of slip at both of the front part wheels. The reference rear wheel slip amount is a reference slip amount representing the states of slip at both of the rear part wheels. Combination of the reference front wheel slip amount and the reference rear wheel slip amount can be one of the followings:

<1> the mean value of the slip amounts for the two front part wheels serving as the reference front wheel slip amount, and the mean value of the slip amounts for the two rear part wheels serving as the reference rear wheel slip amount;
<2> the largest one of the slip amounts for the two front part wheels serving as the reference front wheel slip amount, and the largest one of the slip amounts for the two rear part wheels serving as the reference rear wheel slip amount;
<3> the largest one of the slip amounts for the two front part wheels serving as the reference front wheel slip amount, and the smallest one of the slip amounts for the two rear part wheels serving as the reference rear wheel slip amount;
<4> the smallest one of the slip amounts for the two front part wheels serving as the reference front wheel slip amount, and the largest one of the slip amounts for the two rear part wheels serving as the reference rear wheel slip amount; and
<5> the smallest one of the slip amounts for the two front part wheels serving as the reference front wheel slip amount, and the smallest one of the slip amounts for the two rear part wheels serving as the reference rear wheel slip amount.

Then the correction section 14 proceeds to step 405 to determine whether or not the reference front wheel slip amount is larger than the reference rear wheel slip amount. If the reference front wheel slip amount is larger than the reference rear wheel slip amount, the correction section 14 proceeds to step 410. If the reference front wheel slip amount is smaller than the reference rear wheel slip amount, the correction section 14 proceeds to step 430.

At step 410, the correction section 14 calculates the difference (hereinafter referred to as a slip difference) between the reference front wheel slip amount and the reference rear wheel slip amount. More specifically, this slip difference is a result of the reference front wheel slip amount minus the reference rear wheel slip amount. Then the correction section 14 proceeds to step 415 to determine whether or not this slip difference is equal to or smaller than a predetermined value (i.e. threshold). If the determination at step 415 is negative, the correction section 14 proceeds to step 420 in order to change a correction amount for a target brake force. At step 420, the correction section 14 calculates a rear part correction amount at the present control cycle so that it becomes, as shown in the following equation, equal to the sum of a constant increase amount and a rear part correction amount at the previous control cycle.

(the rear part correction amount at the present control cycle)=(the rear part correction amount at the previous control cycle)+(the constant increase amount) (6)

After step 420, the correction section 14 proceeds to step 425.

If the determination at step 415 is affirmative, the correction section 14 proceeds to step 425 without modifying the rear part correction amount since there is no need for changing the correction amount for the target brake force. At step 425, the correction section 14 assigns zero to a front part correction amount corresponding to the front part wheels having larger slip amounts than the rear part wheels. Then, the correction section 14 proceeds to step 450.

At step 430, the correction section 14 calculates the difference (hereinafter referred to as a slip difference) between the reference rear wheel slip amount and the reference front wheel slip amount. More specifically, this slip difference is a result of the reference rear wheel slip amount minus the reference front wheel slip amount. Then the correction section 14 proceeds to step 435 to determine whether or not this slip difference is equal to or smaller than a predetermined value (i.e. threshold). If the determination at step 435 is negative, the correction section 14 proceeds to step 440 in order to change a correction amount for a target brake force. At step 440, the correction section 14 calculates the front part correction amount at the present control cycle so that it becomes, as shown in the following equation, equal to the sum of a constant increase amount and a front part correction amount at the previous control cycle.

(the front part correction amount at the present control cycle)=(the front part correction amount at the previous control cycle)+(the constant increase amount) (7)

After step 440, the correction section 14 proceeds to step 445.

If the determination at step 435 is affirmative, the correction section 14 proceeds to step 445 without modifying the front part correction amount since there is no need for changing the correction amount for target brake force. At step 445, the correction section 14 assigns zero to the rear part correction amount corresponding to the rear part wheels having larger slip amounts than the front part wheels. Then, the correction section 14 proceeds to step 450.

At step 450, the correction section 14 determines whether or not the subject wheel is a front part wheel. If the determination at step 450 is affirmative, the correction section 14 proceeds to step 455 to calculate the corrected target brake force for the subject wheel based on the following equation (8). If the determination at step 450 is negative, the correction section 14 proceeds to step 460 to calculate the corrected target brake force for the subject wheel based on the following equation (9). The value of the front part correction amount shown in the equation (8) is identical with that calculated in step 425 or step 440. The value of the rear part correction amount shown in the equation (9) is identical with that calculated in step 420 or step 445.

(the corrected target brake force)=(basic brake force for the subject wheel)++(the front part correction amount) (8)

(the corrected target brake force)=(basic brake force for the subject wheel)+(the rear part correction amount) (9)

After step 455 or step 460, the correction section 14 finally proceeds to step 465 to determine whether or not step 450 and following steps have been executed for all of the wheels in the present control cycle. The correction section 14 repeats step 450 and following steps until the determination at step 465 becomes affirmative and terminates the target brake force correction process in the present control cycle when the determination at step 465 becomes affirmative.

As described above, in the target brake force correction process, the brake force distribution control device 1 according to the present embodiment determines the reference front wheel slip amount for the front part wheels and the reference front wheel slip amount for the rear part wheels, sets the correction amounts to be applied to the target brake forces for the front right wheel and the front left wheel to a common value, and sets the correction amounts to be applied to the target brake forces for the rear right wheel and the rear left wheel to a common value. With this operation, the brake forces at the front and rear wheels are controlled so that they becomes the same even if the slip amount of either front or rear wheel becomes larger than the slip amount of an opposite part wheel. Therefore, it is possible to maximize the braking performance of each of the four wheels while keeping proper attitude of the vehicle. In addition, it is possible to prevent the brake forces from being suppressed and accordingly prevent the stopping distance from becoming longer even if the proportion of the loads distributed on the wheels is not estimated correctly because of, for example, significant change in how shipments are mounted to the vehicle.

### Fifth Embodiment

Hereinafter, a fifth embodiment of the present invention is described. In the present embodiment, following modification is given to the first embodiment. In the modification, a reference slip amount for the right side wheels and a reference slip amount for the left side wheels are determined. In addition, in the target brake force correction process, the correction amounts to be applied to the target brake forces for the front right wheel and the rear right wheel are set to a common value, and the correction amounts to be applied to the target brake forces for the front left wheel and the rear left wheel are set to a common value. It should be noted that a basic configuration of the brake force distribution control device 1 according to the present embodiment is identical with that of the first embodiment. The only difference between the first embodiment and the present embodiment is the target brake force correction process executed by target brake force correction section 14. Therefore, the target brake force correction process is described.

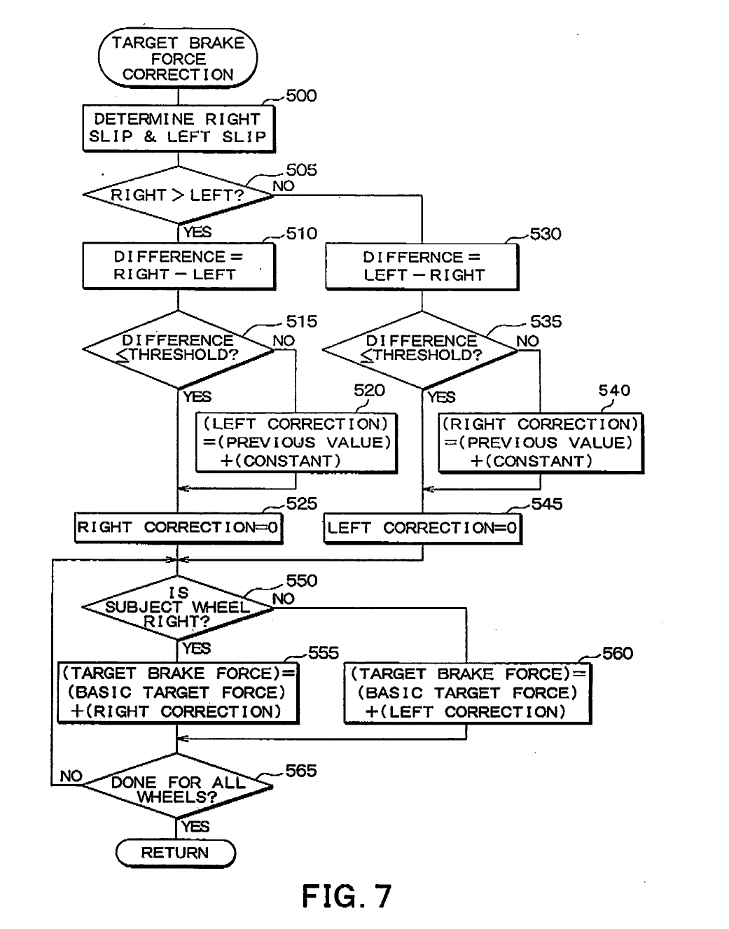

FIG. 7 is a flowchart showing a target brake force correction process for the wheels executed by the target brake force correction section 14 of the brake force distribution control device 1 according to the present embodiment. Based on a program stored in advance, the target brake force correction section 14 executes the target brake force correction process shown in FIG. 7 for the wheels at intervals of a predetermined control period.

On starting the target brake force correction process, the target brake force correction section 14 determines at step 500 a reference right wheel slip amount and a reference left wheel slip amount. The reference right wheel slip amount is a reference slip amount representing the states of slip at both of the left side-wheels. The reference left wheel slip amount is a reference slip amount representing the states of slip at both of the left side wheels. Combination of the reference right wheel slip amount and the reference left wheel slip amount can be one of the followings:

<1> the mean value of the slip amounts for the two right side wheels serving as the reference right wheel slip amount, and the mean value of the slip amounts for the two left side wheels serving as the reference left wheel slip amount;
<2> the largest one of the slip amounts for the two right side wheels serving as the reference right wheel slip amount, and the largest one of the slip amounts for the two left side wheels serving as the reference left wheel slip amount;
<3> the largest one of the slip amounts for the two right side wheels serving as the reference right wheel slip amount, and the smallest one of the slip amounts for the two left side wheels serving as the reference left wheel slip amount;
<4> the smallest one of the slip amounts for the two right side wheels serving as the reference right wheel slip amount, and the largest one of the slip amounts for the two left side wheels serving as the reference left wheel slip amount; and
<5> the smallest one of the slip amounts for the two right side wheels serving as the reference right wheel slip amount, and the smallest one of the slip amounts for the two left side wheels serving as the reference left wheel slip amount.

Then the correction section 14 proceeds to step 505 to determine whether or not the reference right wheel slip amount is larger than the reference left wheel slip amount. If the reference right wheel slip amount is larger than the reference left wheel slip amount, the correction section 14 proceeds to step 510. If the reference right wheel slip amount is smaller than the reference left wheel slip amount, the correction section 14 proceeds to step 530.

At step 510, the correction section 14 calculates the difference (hereinafter referred to as a slip difference) between the reference right wheel slip amount and the reference left wheel slip amount. More specifically, this slip difference is a result of the reference right wheel slip amount minus the reference left wheel slip amount. Then the correction section 14 proceeds to step 515 to determine whether or not this slip difference is equal to or smaller than a predetermined value (i.e. threshold). If the determination at step 515 is negative, the correction section 14 proceeds to step 520 in order to change a correction amount for a target brake force. At step 520, the correction section 14 calculates a left side correction amount at the present control cycle so that it becomes, as shown in the following equation, equal to the sum of a constant increase amount and a left side correction amount at the previous control cycle.

(the left side correction amount at the present control cycle)=(the left side correction amount at the previous control cycle)+(the constant increase, amount) (10)

After step 520, the correction section 14 proceeds to step 525.

If the determination at step 515 is affirmative, the correction section 14 proceeds to step 525 without modifying the left side correction amount since there is no need for changing the correction amount for the target brake force. At step 525, the correction section 14 assigns zero to a right side correction amount corresponding to the right side wheels having larger slip amounts than the left side wheels. Then, the correction section 14 proceeds to step 550.

At step 535, the correction section 14 calculates the difference (hereinafter referred to as a slip difference) between the reference left wheel slip amount and the reference right wheel slip amount. More specifically, this slip difference is a result of the reference left wheel slip amount minus the reference right wheel slip amount. Then the correction section 14 proceeds to step 535 to determine whether or not this slip difference is equal to or smaller than a predetermined value (i.e. threshold). If the determination at step 535 is negative, the correction section 14 proceeds to step 540 in order to change a correction amount for a target brake force. At step 540, the correction section 14 calculates the right side correction amount at the present control cycle so that it becomes, as shown in the following equation, equal to the sum of a constant increase amount and a right side correction amount at the previous control cycle.

(the right side correction amount at the present control cycle)=(the right side correction amount at the previous control cycle)+(the constant increase amount) (11)

After step 540, the correction section 14 proceeds to step 545.

If the determination at step 535 is affirmative, the correction section 14 proceeds to step 545 without modifying the right side correction amount since there is no need for changing the correction amount for target brake force. At step 545, the correction section 14 assigns zero to the left side correction amount corresponding to the left side wheels having larger slip amounts than the right side wheels. Then, the correction section 14 proceeds to step 550.

At step 550, the correction section 14 determines whether or not the subject wheel is a right -side wheel. If the determination at step 550 is affirmative, the correction section 14 proceeds to step 555 to calculate the corrected target brake force for the subject wheel based on the following equation (12). If the determination at step 550 is negative, the correction section 14 proceeds to step 560 to calculate the corrected target brake force for the subject wheel based on the following equation (13). The value of the right side correction amount shown in the equation (12) is identical with that calculated in step 525 or step 540. The value of the left side correction amount shown in the equation (13) is identical with that calculated in step 520 or step 545.

(the corrected target brake force)=(basic brake force for the subject wheel)+(the right side correction amount) (12)

(the corrected target brake force)=(basic brake force for the subject wheel)+(the left side correction amount) (13)

After step 555 or step 560, the correction section 14 finally proceeds to step 565 to determine whether or not step 550 and following steps have been executed for all of the wheels in the present control cycle. The correction section 14 repeats step 550 and following steps until the determination at step 565 becomes affirmative and terminates the target brake force correction process in the present control cycle when the determination at step 565 becomes affirmative.

As described above, in the target brake force correction process, the brake force distribution control device 1 according to the present embodiment determines the reference right wheel slip amount for the right side wheels and the reference left wheel slip amount for the left side wheels, sets the correction amounts to be applied to the target brake forces for the front right wheel and the rear left to a common value, and sets the correction amounts to be applied to the target brake forces for the front left wheel and the rear left wheel to another common value. Suppose that this operation is executed while the vehicle is, for example, turning. In this case, the brake forces at the right and left wheels are controlled so that they becomes the same even if the slip amount of either right or left wheel becomes larger than the slip amount of an opposite side wheel. Therefore, it is possible to maximize the braking performance of each of the four wheels while keeping proper attitude of the vehicle. In addition, it is possible to prevent the brake forces from being suppressed and accordingly prevent the stopping distance from becoming longer even if the proportion of the loads distributed on the wheels is not estimated correctly because of, for example, significant change in how shipments are mounted to the vehicle.

### Sixth Embodiment

Hereinafter, a sixth embodiment of the present invention is described. In the present embodiment, the target brake force correction process using the slip amounts of the wheels is not executed. In the present embodiment, the estimated loads are corrected, and the target brake forces for the wheels are calculated based on the corrected version of the estimated loads.

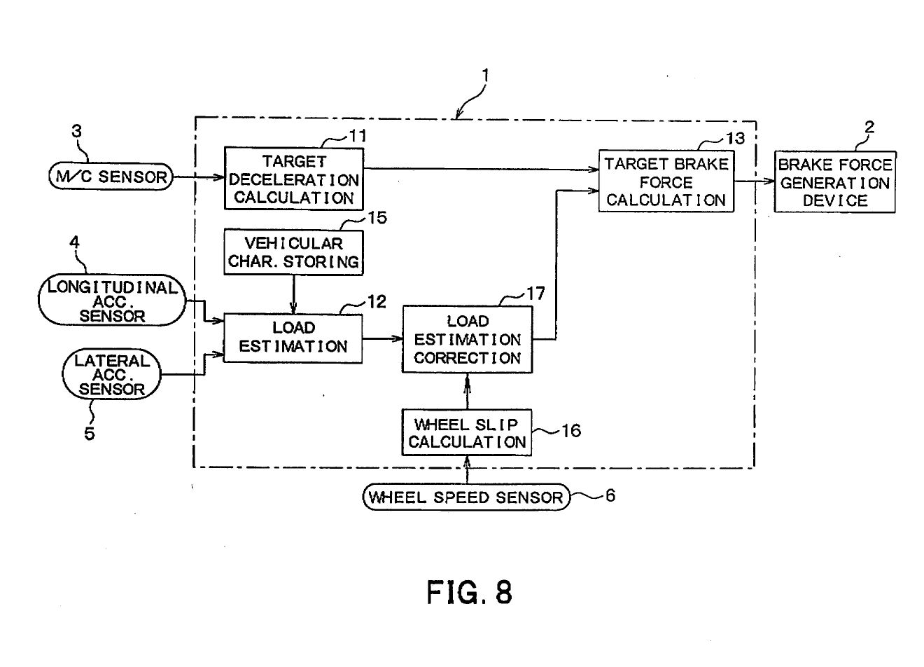

FIG. 8 is a block diagram showing a brake force distribution control device 1 for a vehicle according to the present embodiment. As shown in FIG. 8, the brake force distribution control device 1 in the present embodiment does not include the target brake force correction section 14 and alternatively includes a load estimation correction section 17. The load estimation correction section 17 receives the slip amounts of the wheels calculated by the wheel slip calculation section 16.

The load estimation correction section 17 corrects the estimated loads from the load estimation section 12 based on the received slip amounts. As described above, the slip amounts of the wheels become the same if the brake forces are distributed properly according to the proportion of the loads on the wheels. Therefore, a deviation in the slip amounts means that the brake forces are distributed based on erroneous estimation of the load on the wheels. Therefore, it is possible to maximize the efficiency in braking performance of the wheels if the brake force distribution control device 1 corrects the estimated loads based on the differences between the slip amounts of the wheels and corrects the brake forces to be generated at the wheels based on the corrected versions of the estimated loads (hereinafter referred to as corrected loads).

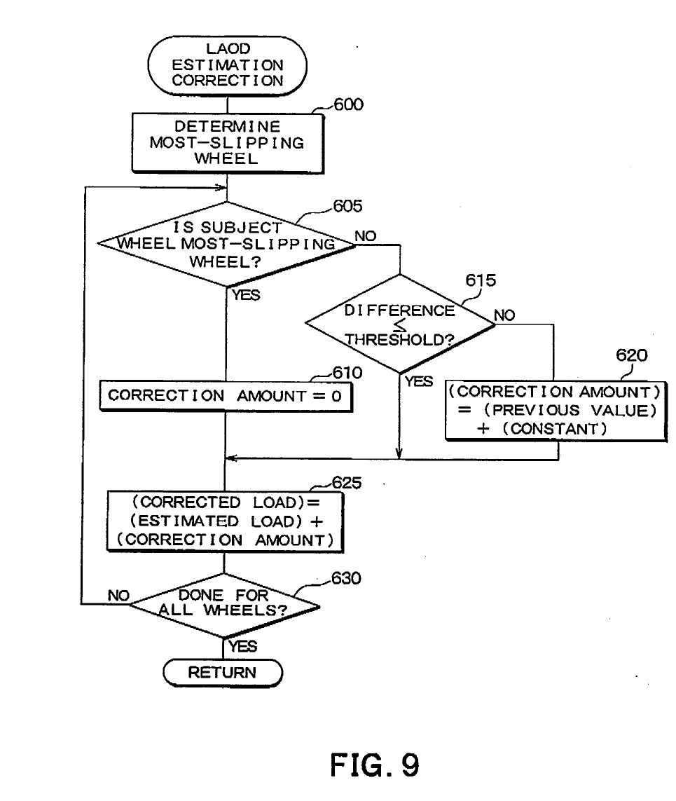

Hereinafter, operation of the brake force distribution control device 1 of the present embodiment is described. FIG. 9 is a flowchart showing a load estimation correction process executed by the load estimation correction section 17. Based on a program stored in advance, the load estimation correction section 17 executes the load estimation correction process shown in FIG. 9 for the wheels at intervals of a predetermined control period.

On starting the load estimation correction process, the load estimation correction section 17 (hereinafter also referred to as a correction section 17) determines at step 600 a most-slipping wheel in the same manner in the step 100 described above.

Then, the correction section 17 proceeds to step 605 to determine whether or not the subject wheel is the most-slipping wheel. If the subject wheel is the most-slipping wheel having the largest slip amount, the correction section 17 proceeds to step 610 to set a load correction amount to zero and then proceeds to step 625. As is described, a brake force of a wheel reaches its maximum when the slip ratio of this wheel becomes approximately 10 percent. Therefore, the most-slipping wheel is the wheel which achieves the best brake efficiency of all of the wheels unless a stability control such as the ABS control and the ESC control is in operation. Therefore, there is no need for correcting the estimated load on the most-slipping wheel and the load correction amount is accordingly set to zero.

If the determination at step 605 is negative, the correction section 17 proceeds to step 615 to determine whether or not a slip difference is equal to or smaller than a predetermined value (i.e. a threshold), wherein the slip difference is the difference between the slip amounts of the most-slipping wheel and the subject wheel. If the determination at step 615 is affirmative, the correction section 17 proceeds to step 625 in order to leave the load correction amount for the subject wheel unchanged from that in the previous control cycle. If the determination at step 615 is negative, the correction section 17 proceeds to step 620 to give modification to the load correction amount for the subject wheel.

At step 620, the correction section 17 calculates a current load correction amount (i.e. a load correction amount at the present control cycle) for the subject wheel. The current load correction amount for the subject wheel is obtained by adding a constant increase amount to the load correction amount for the subject wheel in the previous control cycle, as follows:

(the current load correction amount)=(the load correction amount in the previous control cycle)+(the constant increase amount) (14)

Then, the correction section 17 proceeds to step 625 to obtain the corrected version of the estimated load on the subject wheel by adding the current load correction amount for the subject wheel to the estimated load on the subject wheel, as follows:

(the corrected load)=(the estimated load)+(the current load correction amount) (15)

Then, the correction section 17 proceeds to step 630 to determine whether or not step 605 and following steps have been executed for all of the wheels in the present control cycle. If the determination at step 630 is affirmative, the correction section 17 terminates the present control cycle. If the determination at step 630 is negative, the correction section 17 proceeds to step 605 again in order to execute step 605 and following steps for a wheel which has not become the subject wheel in the present control cycle.

As described above, the brake force distribution control device 1 according to the present embodiment determines the most-slipping wheel having the largest slip amount of all of the wheels, then calculates a difference between the slip amount for the most-slipping wheel and the slip amount for the subject wheel, and then determines the load correction amount for the subject wheel based on the calculated difference. More specifically, the brake force distribution control device 1 increases the load correction amount for the subject wheel by adding the constant increase amount to the load correction amount for the subject wheel in the previous control cycle if the calculated difference is larger than the predetermined value. If the calculated difference is not larger than the predetermined value, the brake force distribution control device 1 uses the load correction amount as it was in the previous control cycle. Thus, the brake force distribution control device 1 increases the brake force for the subject wheel so that the slip amount of the subject wheel comes closer to the slip amount of the most-slipping wheel at a degree of quickness corresponding to the difference between the slip amount for the most-slipping wheel and the slip amount for the subject wheel.

As described above, the slip amounts of the wheels become the same if the brake forces are distributed properly according to the proportion of the loads on the wheels. Therefore, a deviation in the slip amounts means that the brake forces are distributed based on erroneous estimation of the load on the wheels. In this case, it is likely that the most-slipping wheel can achieve most efficient braking performance. Therefore, it is possible to maximize the efficiency in braking performance of the wheels if the brake force distribution control device 1 selects one or more of the wheels having the slip amount smaller than that of the most-slipping wheel, corrects the brake force to be generated at each selected wheel based on the difference between the slip amount for each selected wheel and the slip amount for the most-slipping wheel, and thereby increases the brake force for each selected wheel. Therefore, it is possible to prevent the brake forces from being suppressed and accordingly prevent the stopping distance from becoming longer even if the proportion of the loads distributed on the wheels is not estimated correctly because of, for example, significant change in how shipments are mounted to the vehicle.

### Seventh Embodiment

Hereinafter, a seventh embodiment of the present invention is described. In the present embodiment, following modification is given to the sixth embodiment. In the modification, the wheels of the vehicle are divided into two wheel groups, namely, a right wheel group and a left wheel group. The right wheel group includes the two right side wheels, and the left wheel group includes the two left side wheels. In the load estimation correction process in the present embodiment, the slip amount of a wheel is compared only with the slip amount of the other wheel in the same wheel group. The load correction amount for a wheel is therefore determined based not on the relation with the wheels in the different wheel group but on the relation with the other wheel in the same wheel group. It should be noted that a basic configuration of the brake force distribution control device 1 according to the present embodiment is identical with that of the sixth embodiment. The only difference between the sixth embodiment and the present embodiment is the load estimation correction process executed by the load estimation correction section 17. Therefore, the load estimation correction process is described.

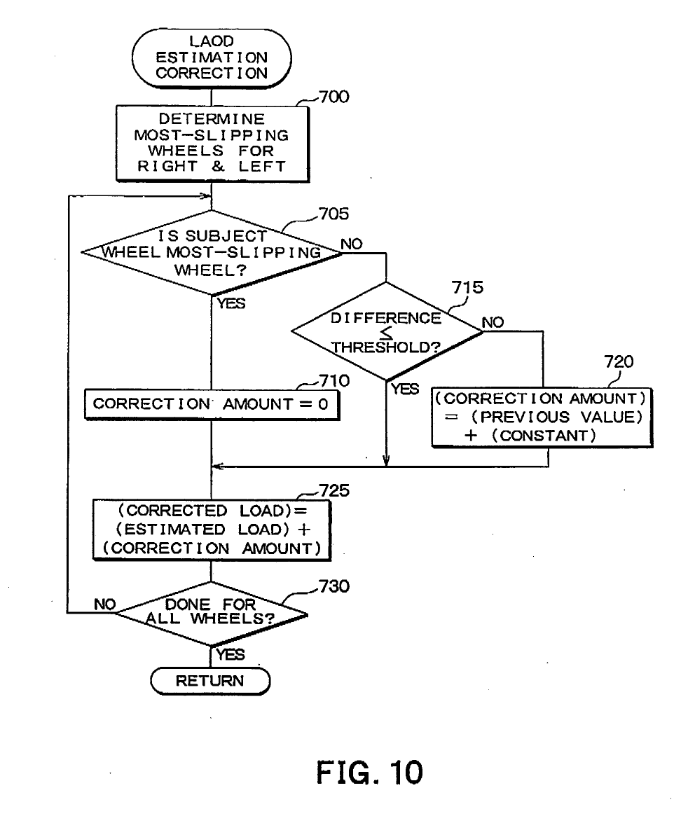

FIG. 10 is a flowchart showing a load estimation correction process for the wheels executed by the load estimation correction section 17 of the brake force distribution control device 1 according to the present embodiment. Based on a program stored in advance, the load estimation correction section 17 executes the load estimation correction process shown in FIG. 10 for the wheels at intervals of a predetermined control period.

On starting the load estimation correction process, the correction section 17 determines at step 700 a most-slipping wheel within each of the right wheel group and the left wheel group. The process in step 700 is executed by applying the method used in step 100 in FIG. 3 to each of the right wheel group and the left wheel group. More specifically, the correction section 17 selects the wheel having the larger slip amount in the right wheel group and the wheel having the larger slip amount in the left wheel group.

Then, the correction section 17 proceeds to step 705 to determine whether or not the subject wheel is the most-slipping wheel in a subject wheel group. If the determination at step 705 is affirmative, the correction section 17 proceeds to step 710 to set the load correction amount to zero and then proceeds to step 725.

If the determination at step 705 is negative, the correction section 17 proceeds to step 715 to determine whether or not a slip difference is equal to or smaller than a predetermined value (i.e. a threshold), wherein the slip difference is the difference between the slip amounts of the most-slipping wheel in the subject wheel group and the subject wheel. If the determination at step 715 is affirmative, the correction section 17 proceeds to step 725 in order to leave the load correction amount for the subject wheel unchanged from that in the previous control cycle. If the determination at step 715 is negative, the correction section 17 proceeds to step 720 to give modification to the load correction amount for the subject wheel.

At step 720, the correction section 17 calculates the load correction amount for the subject wheel in the same manner as step 620. Then the correction section 17 proceeds to step 725 to calculate the corrected version of the estimated load for the subject wheel in the same manner as step 625. Then, the correction section 17 proceeds to step 730 to determine whether or not step 705 and following steps have been executed for all of the wheels in the present control cycle. The correction section 17 repeats step 705 and following steps until the determination at step 730 becomes affirmative and terminates the load estimation correction process in the present control cycle when the determination at step 730 becomes affirmative.

As described above, the wheels of the vehicle is divided into the two wheel groups, namely, the right wheel group and the left wheel group. The right wheel group includes the two right side wheels, and the left wheel group includes the two left side wheels. In the load estimation correction process in the present embodiment, the brake force distribution control device 1 selects one of the four wheels one by one as the subject wheel, compares the slip amount of the subject wheel only with the slip amount of the other wheel in the wheel group to which the subject wheel belongs, and determines the load correction amount based not on the relation with the wheels in the wheel group to which the subject wheel does not belong but on the relation with the other wheel in the wheel group to which the subject wheel belongs to. By separately determining the load correction amounts for the right wheel group and the load correction amounts for the left wheel group, the brake forces generated at the wheels in a wheel group become suitable for conditions at a side of the vehicle where the wheel group is located. Therefore, it is possible to maximize the braking performance of each of the four wheels while keeping proper attitude of the vehicle. In addition, it is possible to prevent the brake forces from being suppressed and accordingly prevent the stopping distance from becoming longer even if the proportion of the wheel loads distributed on the wheels is not estimated correctly because of, for example, significant change in how shipments are mounted to the vehicle.

### Eighth Embodiment

Hereinafter, an eighth embodiment of the present invention is described. In the present embodiment, following modification is given to the sixth embodiment. In the modification, the wheels of the vehicle are divided into two wheel groups, namely, a front wheel group and a rear wheel group. The front wheel group includes the two front part wheels, and the rear wheel group includes the two rear part wheels. In the load estimation correction process in the present embodiment, the slip amount of a wheel is compared only with the slip amount of the other wheel in the same wheel group. The load correction amount for a wheel is therefore determined based not on the relation with the wheels in the different wheel group but on the relation with other wheel in the same wheel group. It should be noted that a basic configuration of the brake force distribution control device 1 according to the present embodiment is identical with that of the sixth embodiment. The only difference between the sixth embodiment and the present embodiment is the load estimation correction process executed by load estimation correction section 17. Therefore, the load estimation correction process is described.

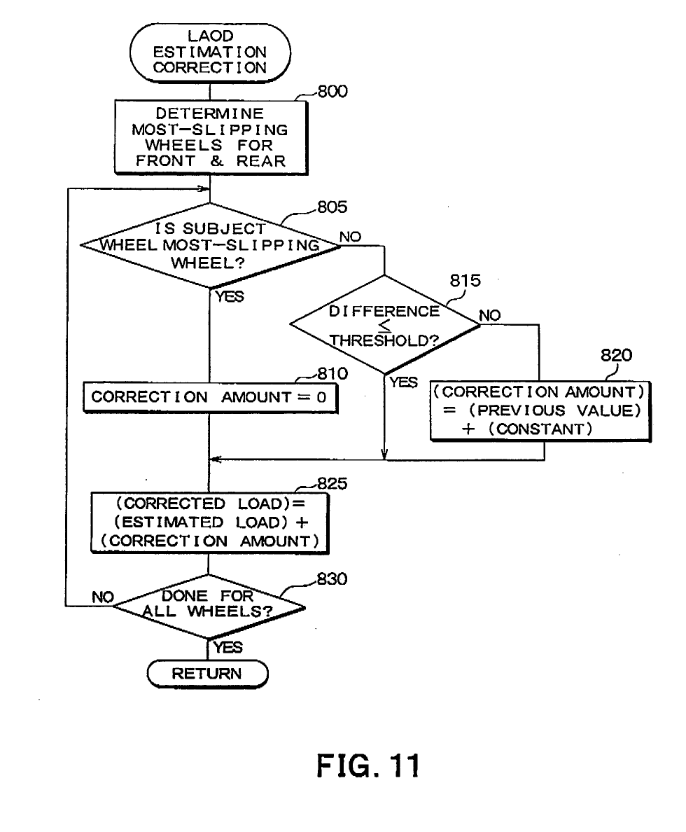

FIG. 11 is a flowchart showing a load estimation correction process for the wheels executed by the load estimation correction section 17 of the brake force distribution control device 1 according to the present embodiment. Based on a program stored in advance, the load estimation correction section 17 executes the load estimation correction process shown in FIG. 11 for the wheels at intervals of a predetermined control period.

On starting the load estimation correction process, the load estimation correction section 17 determines at step 800 a most-slipping wheel for each of the front wheel group and the rear wheel group. The process in step 800 is executed by applying the method used in step 100 in FIG. 3 to each of the front wheel group and the rear wheel group. More specifically, the correction section 17 selects the wheel having the larger slip amount in the front wheel group and the wheel having the larger slip amount in the rear wheel group.

Then, the correction section 17 proceeds to step 805 to determine whether or not the subject wheel is the most-slipping wheel in a subject wheel group. The subject wheel group is the wheel group to which the subject wheel belongs. Therefore, the subject wheel group is the front wheel group if the subject wheel is one of the front right wheel and the front left wheel, and the subject wheel group is the rear wheel group if the subject wheel is one of the rear right wheel and the rear left wheel. If the determination at step 805 is affirmative, the correction section 17 proceeds to step 810 to set the load correction amount to zero and then proceeds to step 825.

If the determination at step 805 is negative, the correction section 17 proceeds to step 815 to determine whether or not a slip difference is equal to or smaller than a predetermined value (i.e. a threshold), wherein the slip difference is the difference between the slip amounts of the most-slipping wheel in the subject wheel group and the subject wheel. If the determination at step 815 is affirmative, the correction section 17 proceeds to step 825 in order to leave the load correction amount for the subject wheel unchanged from that in the previous control cycle. If the determination at step 815 is negative, the correction section 17 proceeds to step 820 to give modification to the load correction amount for the subject wheel.

At step 820, the correction section 17 calculates the load correction amount for the subject wheel in the same manner as step 620. Then the correction section 17 proceeds to step 825 to calculate the corrected version of the estimated load on the subject wheel in the same manner as step 625. Then, the correction section 17 proceeds to step 830 to determine whether or not step 805 and following steps have been executed for all of the wheels in the present control cycle. The correction section 17 repeats step 805 and following steps until the determination at step 830 becomes affirmative and terminates the load estimation correction process in the present control cycle when the determination at step 830 becomes affirmative.

As described above, the wheels of the vehicle is divided into the two wheel groups, namely, the front wheel group and the rear wheel group. The front wheel group includes the two front part wheels, and the rear wheel group includes the two rear part wheels. In the load estimation correction process in the present embodiment, the brake force distribution control device 1 selects one of the four wheels one by one as the subject wheel, compares the slip amount of the subject wheel only with the slip amount of the other wheel in the wheel group to which the subject wheel belongs, and determines the load correction amounts based not on the relation with the wheels in the wheel group to which the subject wheel does not belong but on the relation with the other wheel in the wheel group to which the subject wheel belongs to. By separately determining the load correction amounts for the front wheel group and the load correction amounts for the rear wheel group, it is possible to properly control the brake forces generated at the front wheels and the rear wheels. Therefore, it is possible to maximize the braking performance of each of the four wheels while keeping proper attitude of the vehicle. In addition, it is possible to prevent the brake forces from being suppressed and accordingly prevent the stopping distance from becoming longer even if the proportion of the loads distributed on the wheels is not estimated correctly because of, for example, significant change in how shipments are mounted to the vehicle.

### Ninth Embodiment

Hereinafter, a ninth embodiment of the present invention is described. In the present embodiment, following modification is given to the sixth embodiment. In the modification, a reference slip amount for the front part wheels and a reference slip amount for the rear part wheels are determined. In addition, in the load estimation correction process, the correction amounts to be applied to the estimated loads on the front right wheel and front left wheel are set to a common value, and the correction amounts to be applied to the estimated loads on the rear right wheel and rear left wheel are set to a common value. It should be noted that a basic configuration of the brake force distribution control device 1 according to the present embodiment is identical with that of the sixth embodiment. The only difference between the sixth embodiment and the present embodiment is the load estimation correction process executed by load estimation correction section 17. Therefore, the load estimation correction process is described.

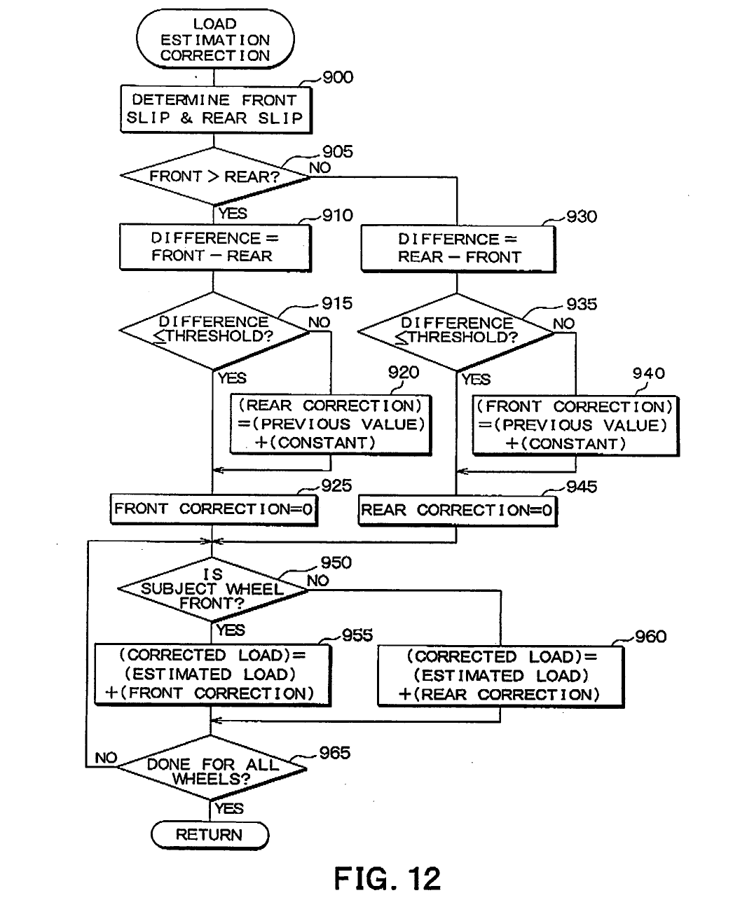

FIG. 12 is a flowchart showing a load estimation correction process for the wheels executed by the load estimation correction section 17 of the brake force distribution control device 1 according to the present embodiment. Based on a program stored in advance, the load estimation correction section 17 executes the load estimation correction process shown in FIG. 12 for the wheels at intervals of a predetermined control period.

On starting the load estimation correction process, the load estimation correction section 17 determines at step 900 a reference front wheel slip amount and a reference rear wheel slip amount. The reference front wheel slip amount is a reference slip amount representing the states of slip at both of the front part wheels. The reference rear wheel slip amount is a reference slip amount representing the states of slip at both of the rear part wheels. Combination of the reference front wheel slip amount and the reference rear wheel slip amount can be any one of <1> to <5> described in the above description for step 400.

Then the correction section 17 proceeds to step 905 to determine whether or not the reference front wheel slip amount is larger than the reference rear wheel slip amount. If the reference front wheel slip amount is larger than the reference rear wheel slip amount, the correction section 17 proceeds to step 910. If the reference front wheel slip amount is smaller than the reference rear wheel slip amount, the correction section 17 proceeds to step 930.

At step 910, the correction section 17 calculates the difference (hereinafter referred to as a slip difference) between the reference front wheel slip amount and the reference rear wheel slip amount. More specifically, this slip difference is a result of the reference front wheel slip amount minus the reference rear wheel slip amount. Then the correction section 17 proceeds to step 915 to determine whether or not this slip difference is equal to or smaller than a predetermined value (i.e. threshold). If the determination at step 915 is negative, the correction section 17 proceeds to step 920 in order to change a correction amount for an estimated load. At step 920, the correction section 17 calculates a rear part correction amount at the present control cycle so that it becomes, as shown in the following equation, equal to the sum of a constant increase amount and a rear part correction amount at the previous control cycle.

(the rear part correction amount at the present control cycle)=(the rear part correction amount at the previous control cycle)+(the constant increase amount) (16)

After step 920, the correction section 17 proceeds to step 925.

If the determination at step 915 is affirmative, the correction section 17 proceeds to step 925 without modifying the rear part correction amount since there is no need for changing the correction amount for the estimated load. At step 925, the correction section 17 assigns zero to a front part correction amount corresponding to the front part wheels having larger slip amounts than the rear part wheels. Then, the correction section 17 proceeds to step 950.

At step 930, the correction section 17 calculates the difference (hereinafter referred to as a slip difference) between the reference rear wheel slip amount and the reference front wheel slip amount. More specifically, this slip difference is a result of the reference rear wheel slip amount minus the reference front wheel slip amount. Then the correction section 17 proceeds to step 935 to determine whether or not this slip difference is equal to or smaller than a predetermined value (i.e. threshold). If the determination at step 935 is negative, the correction section 17 proceeds to step 940 in order to change a correction amount for an estimated load. At step 940, the correction section 17 calculates the front part correction amount at the present control cycle so that it becomes, as shown in the following equation, equal to the sum of a constant increase amount and a front part correction amount at the previous control cycle.

(the front part correction amount at the present control cycle)=(the front part correction amount at the previous control cycle)+(the constant increase amount) (17)

After step 940, the correction section 17 proceeds to step 945.

If the determination at step 935 is affirmative, the correction section 17 proceeds to step 945 without modifying the front part correction amount since there is no need for changing the correction amount for estimated load. At step 945, the correction section 17 assigns zero to the rear part correction amount corresponding to the rear part wheels having larger slip amounts than the front part wheels. Then, the correction section 17 proceeds to step 950.

At step 950, the correction section 17 determines whether or not the subject wheel is a front part wheel. If the determination at step 950 is affirmative, the correction section 17 proceeds to step 955 to calculate the corrected version of the estimated load on the subject wheel based on the following equation (18). If the determination at step 950 is negative, the correction section 17 proceeds to step 960 to calculate the corrected version of the estimated load on the subject wheel based on the following equation (19).

The value of the front part correction amount shown in the equation (18) is identical with that calculated in step 925 or step 940. The value of the rear part correction amount shown in the equation (19) is identical with that calculated in step 920 or step 945.

(the corrected version of the estimated load)=(the estimated load for the subject wheel)+(the front part correction amount) (18)

(the corrected version of the estimated load)=(the estimated load for the subject wheel)+(the rear part correction amount) (19)

After step 955 or step 960, the correction section 17 finally proceeds to step 965 to determine whether or not step 950 and following steps have been executed for all of the wheels in the present control cycle. The correction section 17 repeats step 950 and following steps until the determination at step 965 becomes affirmative and terminates the load estimation correction process in the present control cycle when the determination at step 965 becomes affirmative.

As described above, in the load estimation correction process, the brake force distribution control device 1 according to the present embodiment determines the reference front wheel slip amount for the front part wheels and the reference front wheel slip amount for the rear part wheels, sets the correction amounts to be applied to the estimated loads on the front right wheel and the front left wheel to a common value, and sets the correction amounts to be applied to the estimated loads on the rear right wheel and the rear left wheel to another common value. With this operation, the brake forces at the front and rear wheels are controlled so that they becomes the same even if the slip amount of either front or rear wheel becomes larger than the slip amount of an opposite part wheel. Therefore, it is possible to maximize the braking performance of each of the four wheels. In addition, it is possible to prevent the brake forces from being suppressed and accordingly prevent the stopping distance from becoming longer even if the proportion of the loads distributed on the wheels is not estimated correctly because of, for example, significant change in how shipments are mounted to the vehicle.

### Tenth Embodiment

Hereinafter, a tenth embodiment of the present invention is described. In the present embodiment, following modification is given to the sixth embodiment. In the modification, a reference slip amount for the right side wheels and a reference slip amount for the left side wheels are determined. In addition, in the load estimation correction process, the correction amounts to be applied to the estimated loads on the front right wheel and the rear right wheel are set to a common value, and the correction amounts to be applied to the estimated loads on the front left wheel and the rear left wheel are set to a common value. It should be noted that a basic configuration of the brake force distribution control device 1 according to the present embodiment is identical with that of the sixth embodiment. The only difference between the sixth embodiment and the present embodiment is the load estimation correction process executed by load estimation correction section 17. Therefore, the load estimation correction process is described.

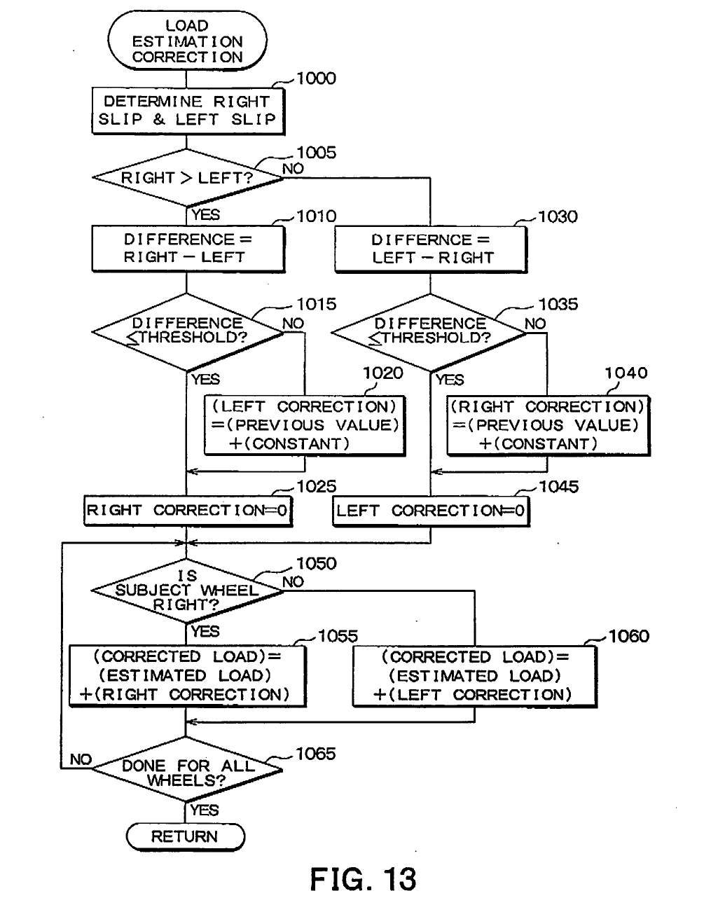

FIG. 13 is a flowchart showing a load estimation correction process for the wheels executed by the load estimation correction section 17 of the brake force distribution control device 1 according to the present embodiment. Based on a program stored in advance, the load estimation correction section 17 executes the load estimation correction process shown in FIG. 13 for the wheels at intervals of a predetermined control period.

On starting the load estimation correction process, the load estimation correction section 17 determines at step 1000 a reference right wheel slip amount and a reference left wheel slip amount. The reference right wheel slip amount is a reference slip amount representing the states of slip at both of the left side wheels. The reference left wheel slip amount is a reference slip amount representing the states of slip at both of the left side wheels. Combination of the reference right wheel slip amount and the reference left wheel slip amount can be any one of <1> to <5> described in the above description for step 500.

Then the correction section 17 proceeds to step 1005 to determine whether or not the reference right wheel slip amount is larger than the reference left wheel slip amount. If the reference right wheel slip amount is larger than the reference left wheel slip amount, the correction section 17 proceeds to step 1010. If the reference right wheel slip amount is smaller than the reference left wheel slip amount, the correction section 17 proceeds to step 1030.

At step 1010, the correction section 17 calculates the difference (hereinafter referred to as a slip difference) between the reference right wheel slip amount and the reference left wheel slip amount. More specifically, this slip difference is a result of the reference right wheel slip amount minus the reference left wheel slip amount. Then the correction section 17 proceeds to step 1015 to determine whether or not this slip difference is equal to or smaller than a predetermined value (i.e. threshold). If the determination at step 1015 is negative, the correction section 17 proceeds to step 1020 in order to change a correction amount for an estimated load. At step 1020, the correction section 17 calculates a left side correction amount at the present control cycle so that it becomes, as shown in the following equation, equal to the sum of a constant increase amount and a left side correction amount at the previous control cycle.

(the left side correction amount at the present control cycle)=(the left side correction amount at the previous control cycle)+(the constant increase amount) (20)

After step 1020, the correction section 17 proceeds to step 1025.

If the determination at step 1015 is affirmative, the correction section 17 proceeds to step 1025 without modifying the left side correction amount since there is no need for changing the correction amount for the estimated load. At step 1025, the correction section 17 assigns zero to a right side correction amount corresponding to the right side wheels having larger slip amounts than the left side wheels. Then, the correction section 17 proceeds to step 1050.

At step 1035, the correction section 17 calculates the difference (hereinafter referred to as a slip difference) between the reference left wheel slip amount and the reference right wheel slip amount. More specifically, this slip difference is a result of the reference left wheel slip amount minus the reference right wheel slip amount. Then the correction section 17 proceeds to step 1035 to determine whether or not this slip difference is equal to or smaller than a predetermined value (i.e. threshold). If the determination at step 1035 is negative, the correction section 17 proceeds to step 1040 in order to change a correction amount for an estimated load. At step 1040, the correction section 17 calculates the right side correction amount at the present control cycle so that it becomes, as shown in the following equation, equal to the sum of a constant increase amount and a right side correction amount at the previous control cycle.

(the right side correction amount at the present control cycle)=(the right side correction amount at the previous control cycle)+(the constant increase amount) (21)

After step 1040, the correction section 17 proceeds to step 1045.

If the determination at step 1035 is affirmative, the correction section 17 proceeds to step 1045 without modifying the right side correction amount since there is no need for changing the correction amount for estimated load. At step 1045, the correction section 17 assigns zero to the left side correction amount corresponding to the left side wheels having larger slip amounts than the right side wheels. Then, the correction section 17 proceeds to step 1050.

At step 1050, the correction section 17 determines whether or not the subject wheel is a right side wheel. If the determination at step 1050 is affirmative, the correction section 17 proceeds to step 1055 to calculate the corrected version of the estimated load on the subject wheel based on the following equation (22). If the determination at step 1050 is negative, the correction section 17 proceeds to step 1060 to calculate the corrected version of the estimated load on the subject wheel based on the following equation (23). The value of the right side correction amount shown in the equation (22) is identical with that calculated in step 1025 or step 1040. The value of the left side correction amount shown in the equation (23) is identical with that calculated in step 1020 or step 1045.

(the corrected version of the estimated load)=(the estimated load on the subject wheel)+(the right side correction amount) (22)

(the corrected version of the estimated load)=(the estimated load on the subject wheel)+(the left side correction amount) (23)

After step 1055 or step 1060, the correction section 17 finally proceeds to step 1065 to determine whether or not step 1050 and following steps have been executed for all of the wheels in the present control cycle. The correction section 17 repeats step 1050 and following steps until the determination at step 1065 becomes affirmative and terminates the load estimation correction process in the present control cycle when the determination at step 1065 becomes affirmative.

As described above, in the load estimation correction process, the brake force distribution control device 1 according to the present embodiment determines the reference right wheel slip amount for the right side wheels and the reference left wheel slip amount for the left side wheels, sets the correction amounts to be applied to the estimated loads on the front right wheel and the rear right wheel to a common value, and sets the correction amounts to be applied to the estimated loads on the front left wheel and the rear left wheel to another common value. Suppose that this operation is executed while the vehicle is, for example, turning. In this case, the brake forces at the right and left wheels are controlled so that they becomes the same even if the slip amount of either right or left wheel becomes larger than the slip amount of an opposite side wheel. Therefore, it is possible to maximize the braking performance of each of the four wheels while keeping proper attitude of the vehicle. In addition, it is possible to prevent the brake forces from being suppressed and accordingly prevent the stopping distance from becoming longer even if the proportion of the loads distributed on the wheels is not estimated correctly because of, for example, significant change in how shipments are mounted to the vehicle.

### Eleventh Embodiment

Hereinafter, an eleventh embodiment of the present invention is described. In the present embodiment, the target brake force correction process using the slip amounts of the wheels is not executed. In addition, the present embodiment is different from the sixth embodiment in that the brake force distribution control device 1 according to the present embodiment does not correct the estimated loads. The brake force distribution control device 1 according to the present embodiment corrects values of the vehicular characteristics and estimates the loads on the wheels based on the corrected vehicular characteristics.

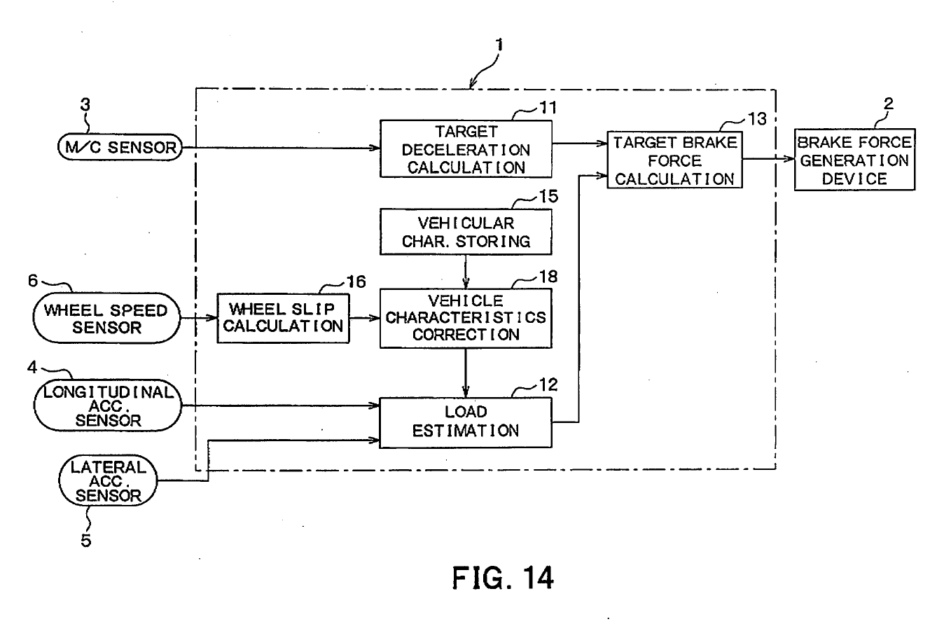

FIG. 14 is a block diagram showing a brake force distribution control device 1 for a vehicle according to the present embodiment. As shown in FIG. 8, the brake force distribution control device 1 in the present embodiment does not include the target brake force correction section 14 and alternatively includes a vehicular characteristics correction section 18. The vehicular characteristics correction section 18 receives the slip amounts of the wheels calculated by the wheel slip calculation section 16.

The vehicular characteristics correction section 18 corrects, based on the received slip amounts, the vehicular characteristics obtained from the vehicular characteristics storing section 15. As described above, the slip amounts of the wheels become the same if the brake forces are distributed properly according to the proportion of the loads on the wheels. Therefore, a deviation in the slip amounts means that the brake forces are distributed based on erroneous estimation of the load on the wheels. Therefore, it is possible to correct indirectly the brake forces to be generated at the wheels and thereby maximize the efficiency in braking performance of the wheels if the brake force distribution control device 1 corrects the vehicular characteristics based on the differences between the slip amounts of the wheels and thereby estimates the loads on the wheels more correctly.

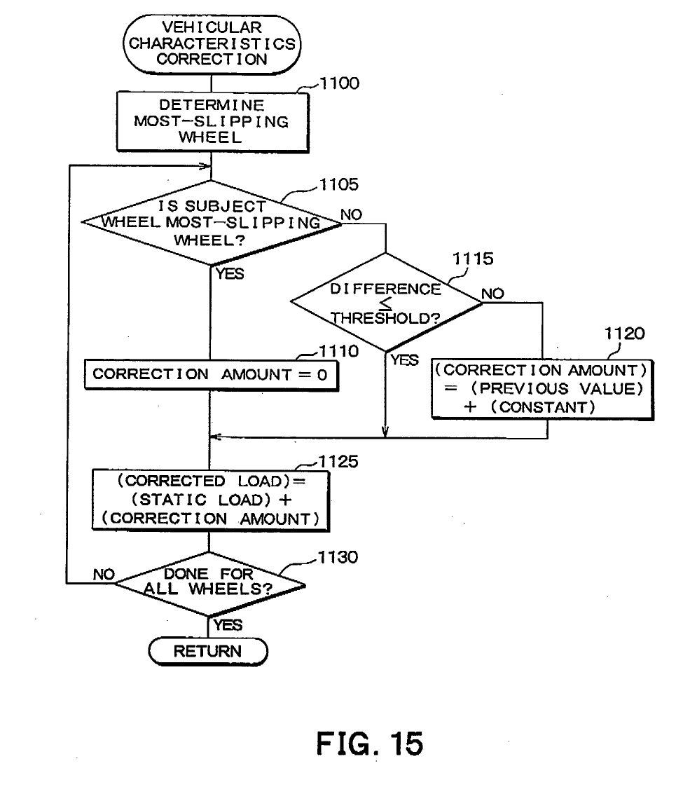

Hereinafter, operation of the brake force distribution control device 1 of the present embodiment is described. FIG. 15 is a flowchart showing a vehicular characteristics correction process executed by the vehicular characteristics correction section 18. Based on a program stored in advance, the vehicular characteristics correction section 18 executes the vehicular characteristics correction process shown in FIG. 15 for the wheels at intervals of a predetermined control period.

On starting the vehicular characteristics correction process, the vehicular characteristics correction section 18 (hereinafter also referred to as a correction section 18) determines at step 1100 a most-slipping wheel in the same manner in the step 100 described above.

Then, the correction section 18 proceeds to step 1105 to determine whether or not the subject wheel is the most-slipping wheel. If the subject wheel is the most-slipping wheel having the largest slip amount, the correction section 18 proceeds to step 1110 to set a load correction amount to zero and then proceeds to step 1125. As is described, a brake force of a wheel reaches its maximum when the slip ratio of this wheel becomes approximately 10 percent. Therefore, the most-slipping wheel is the wheel which achieves the best brake efficiency of all of the wheels unless a stability control such as the ABS control and the ESC control is in operation. Therefore, there is no need for correcting the vehicular characteristics for the most-slipping wheel and the load correction amount is accordingly set to zero.

If the determination at step 1105 is negative, the correction section 18 proceeds to step 1115 to determine whether or not a slip difference is equal to or smaller than a predetermined value (i.e. a threshold), wherein the slip difference is the difference between the slip amounts of the most-slipping wheel and the subject wheel. If the determination at step 1115 is affirmative, the correction section 18 proceeds to step 1125 in order to leave the load correction amount for the subject wheel unchanged from that in the previous control cycle. If the determination at step 1115 is negative, the correction section 18 proceeds to step 1120 to give modification to the load correction amount for the subject wheel.

At step 1120; the correction section 18 calculates the current load correction amount (i.e. a load correction amount at the present control cycle) for the subject wheel. The current load correction amount for the subject wheel is obtained by adding a constant increase amount to the load correction amount for the subject wheel in the previous control cycle, as follows:

(the current load correction amount)=(the load correction amount in the previous control cycle)+(the constant increase amount) (24)

Then, the correction section 18 proceeds to step 1125 to obtain a corrected version of a static load on the subject wheel by adding the current load correction amount for the subject wheel to the static load on the subject wheel stored in the vehicular characteristics storing section 15, as is shown by the equation (25). A static load on a wheel is defined to be a load on the wheel in the case that the vehicle is standing still (that is, the vehicle is not moving). The corrected version of a static load is hereinafter referred to as the corrected static load.

(the corrected static load)=(the static load)+(the load correction amount) (25)

Then, the correction section 18 proceeds to step 1130 to determine whether or not step 1105 and following steps have been executed for all of the wheels in the present control cycle. If the determination at step 1130 is affirmative, the correction section 18 terminates the present control cycle. If the determination at step 1130 is negative, the correction section 18 proceeds to step 1105 again in order to execute step 1105 and following steps for a wheel which has not become the subject wheel in the present control cycle.

When the corrected static loads on the wheels are calculated, the load estimation section 12 assigns, for example, the corrected static load on the front right wheel to the static load W_{FRO} on the front right wheel in the equation (1) shown above. Thus, the corrected static loads on the wheels are used by the load estimation section 12 when the load estimation section 12 estimates the loads on the wheels.

Therefore, it is possible to estimate the loads on the wheels according to the vehicular characteristics which are corrected based on the slip amounts of the wheels. Therefore, it is possible to estimate the loads on the wheels more correctly.

As described above, the brake force distribution control device 1 according to the present embodiment determines the most-slipping wheel having the largest slip amount of all of the wheels, then calculates a difference between the slip amount for the most-slipping wheel and the slip amount for the subject wheel, and then determines the load correction amount for the subject wheel based on the calculated difference. More specifically, the brake force distribution control device 1 increases the load correction amount for the subject wheel by adding the constant increase amount to the load correction amount for the subject wheel in the previous control cycle if the calculated difference is larger than the predetermined value. If the calculated difference is not larger than the predetermined value, the brake force distribution control device 1 uses the load correction amount as it was in the previous control cycle. Thus, the brake force distribution control device 1 increases the brake force for the subject wheel so that the slip amount of the subject wheel comes closer to the slip amount of the most-slipping wheel at a degree of quickness corresponding to the difference between the slip amount for the most-slipping wheel and the slip amount for the subject wheel.

As described above, the slip amounts of the wheels become the same if the brake forces are distributed properly according to the proportion of the loads on the wheels. Therefore, a deviation in the slip amounts means that the brake forces are distributed based on erroneous estimation of the load on the wheels. In this case, it is likely that the most-slipping wheel can achieve most efficient braking performance. Therefore, it is possible to maximize the efficiency in braking performance of the wheels if the brake force distribution control device 1 selects one or more of the wheels having the slip amount smaller than that of the most-slipping wheel, corrects the brake force to be generated at each selected wheel based on the difference between the slip amount for each selected wheel and the slip amount for the most-slipping wheel, and thereby increases the brake force for each selected wheel. Therefore, it is possible to prevent the brake forces from being suppressed and accordingly prevent the stopping distance from becoming longer even if, for example, significant change occurs in how shipments are mounted to the vehicle.

### Twelfth Embodiment

Hereinafter, a twelfth embodiment of the present invention is described. In the present embodiment, following modification is given to the eleventh embodiment. In the modification, the wheels of the vehicle are divided into two wheel groups, namely, a right wheel group and a left wheel group. The right wheel group includes the two right side wheels, and the left wheel group includes the two left side wheels. In the vehicular characteristics correction process in the present embodiment, the slip amount of a wheel is compared only with the slip amount of the other wheel in the same wheel group. The load correction amount for a wheel is therefore determined based not on the relation with the wheels in the different wheel group but on the relation with the other wheel in the same wheel group. It should be noted that a basic configuration of the brake force distribution control device 1 according to the present embodiment is identical with that of the eleventh embodiment. The only difference between the eleventh embodiment and the present embodiment is the vehicular characteristics correction process executed by the vehicular characteristics correction section 18. Therefore, the vehicular characteristics correction process is described.

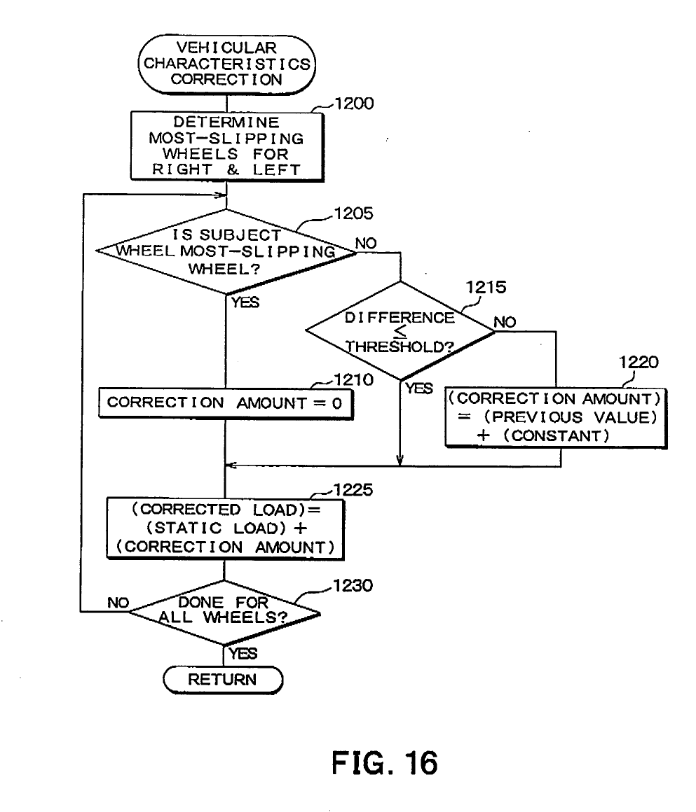

FIG. 16 is a flowchart showing a vehicular characteristics correction process for the wheels executed by the vehicular characteristics correction section 18 of the brake force distribution control device 1 according to the present embodiment. Based on a program stored in advance, the vehicular characteristics correction section 18 executes the vehicular characteristics correction process shown in FIG. 16 for the wheels at intervals of a predetermined control period.

On starting the vehicular characteristics correction process, the correction section 18 determines at step 1200 a most-slipping wheel within each of the right wheel group and the left wheel group. The process in step 1200 is executed by applying the method used in step 100 in FIG. 3 to each of the right wheel group and the left wheel group. More specifically, the correction section 18 selects the wheel having the larger slip amount in the right wheel group and the wheel having the larger slip amount in the left wheel group.

Then, the correction section 18 proceeds to step 1205 to determine whether or not the subject wheel is the most-slipping wheel in a subject wheel group. If the determination at step 1205 is affirmative, the correction section 18 proceeds to step 1210 to set the load correction amount to zero and then proceeds to step 1225.

If the determination at step 1205 is negative, the correction section 18 proceeds to step 1215 to determine whether or not a slip difference is equal to or smaller than a predetermined value (i.e. a threshold), wherein the slip difference is the difference between the slip amounts of the most-slipping wheel in the subject wheel group and the subject wheel. If the determination at step 1215 is affirmative, the correction section 18 proceeds to step 1225 in order to leave the load correction amount for the subject wheel unchanged from that in the previous control cycle. If the determination at step 1215 is negative, the correction section 18 proceeds to step 1220 to give modification to the load correction amount for the subject wheel.

At step 1220, the correction section 18 calculates the load correction amount for the subject wheel in the same manner as step 1120. Then the correction section 18 proceeds to step 1225 to calculate the corrected version of the static load on the subject wheel in the same manner as step 1125. Then, the correction section 18 proceeds to step 1230 to determine whether or not step 1205 and following steps have been executed for all of the wheels in the present control cycle. The correction section 18 repeats step 1205 and following steps until the determination at step 1230 becomes affirmative and terminates the vehicular characteristics correction process in the present control cycle when the determination at step 1230 becomes affirmative.

As described above, the wheels of the vehicle is divided into the two wheel groups, namely, the right wheel group and the left wheel group. The right wheel group includes the two right side wheels, and the left wheel group includes the two left side wheels. In the vehicular characteristics correction process in the present embodiment, the brake force distribution control device 1 selects one of the four wheels one by one as the subject wheel, compares the slip amount of the subject wheel only with the slip amount of the other wheel in the wheel group to which the subject wheel belongs, and determines the load correction amount based not on the relation with the wheels in the wheel group to which the subject wheel does not belong but on the relation with the other wheel in the wheel group to which the subject wheel belongs to. By separately determining the load correction amounts for the right wheel group and the load correction amounts for the left wheel group, the brake forces generated at the wheels in a wheel group become suitable for conditions at a side of the vehicle where the wheel group is located. Therefore, it is possible to maximize the braking performance of each of the four wheels while keeping proper attitude of the vehicle. In addition, it is possible to prevent the brake forces from being suppressed and accordingly prevent the stopping distance from becoming longer even if, for example, significant change occurs in how shipments are mounted to the vehicle.

### Thirteenth Embodiment

Hereinafter, a thirteenth embodiment of the present invention is described. In the present embodiment, following modification is given to the eleventh embodiment. In the modification, the wheels of the vehicle are divided into two wheel groups, namely, a front wheel group and a rear wheel group. The front wheel group includes the two front part wheels, and the rear wheel group includes the two rear part wheels. In the vehicular characteristics correction process in the present embodiment, the slip amount of a wheel is compared only with the slip amount of the other wheel in the same wheel group. The load correction amount for a wheel is therefore determined based not on the relation with the wheels in the different wheel group but on the relation with other wheel in the same wheel group. It should be noted that a basic configuration of the brake force distribution control device 1 according to the present embodiment is identical with that of the eleventh embodiment. The only difference between the eleventh embodiment and the present embodiment is the vehicular characteristics correction process executed by vehicular characteristics correction section 18. Therefore, the vehicular characteristics correction process is described.

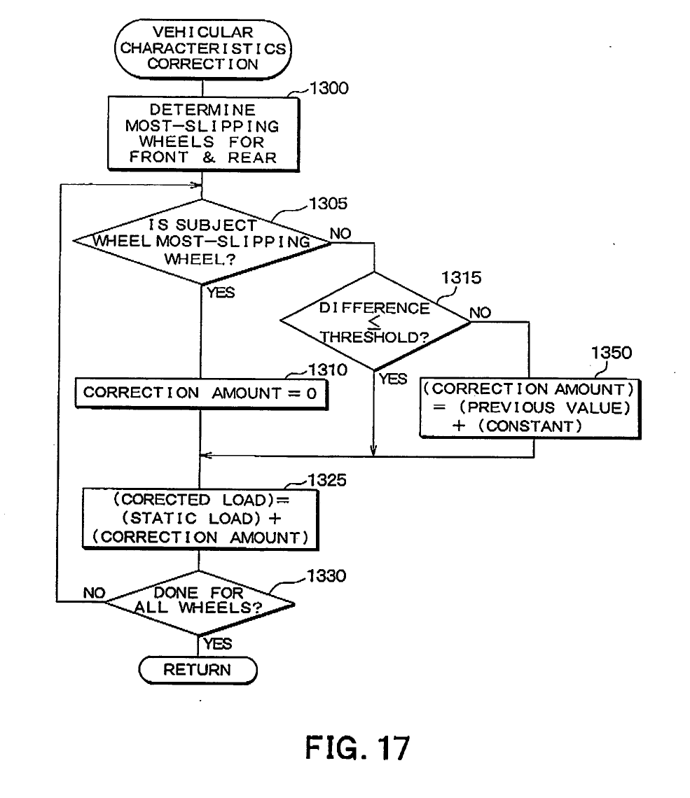

FIG. 17 is a flowchart showing a vehicular characteristics correction process for the wheels executed by the vehicular characteristics correction section 18 of the brake force distribution control device 1 according to the present embodiment. Based on a program stored in advance, the vehicular characteristics correction section 18 executes the vehicular characteristics correction process shown in FIG. 17 for the wheels at intervals of a predetermined control period.

On starting the vehicular characteristics correction process, the vehicular characteristics correction section 18 determines at step 1300 a most-slipping wheel for each of the front wheel group and the rear wheel group. The process in step 1300 is executed by applying the method used in step 100 in FIG. 3 to each of the front wheel group and the rear wheel group. More specifically, the correction section 18 selects the wheel having the larger slip amount in the front wheel group and the wheel having the larger slip amount in the rear wheel group.

Then, the correction section 18 proceeds to step 1305 to determine whether or not the subject wheel is the most-slipping wheel in a subject wheel group. The subject wheel group is the wheel group to which the subject wheel belongs. Therefore, the subject wheel group is the front wheel group if the subject wheel is one of the front right wheel and the front left wheel, and the subject wheel group is the rear wheel group if the subject wheel is one of the rear right wheel and the rear left wheel. If the determination at step 1305 is affirmative, the correction section 18 proceeds to step 1310 to set the load correction amount to zero and then proceeds to step 1325.

If the determination at step 1305 is negative, the correction section 18 proceeds to step 1315 to determine whether or not a slip difference is equal to or smaller than a predetermined value (i.e. a threshold), wherein the slip difference is the difference between the slip amounts of the most-slipping wheel in the subject wheel group and the subject wheel. If the determination at step 1315 is affirmative, the correction section 18 proceeds to step 1325 in order to leave the load correction amount for the subject wheel unchanged from that in the previous control cycle. If the determination at step 1315 is negative, the correction section 18 proceeds to step 1320 to give modification to the load correction amount for the subject wheel.

At step 1320, the correction section 18 calculates the load correction amount for the subject wheel in the same manner as step 1120. Then the correction section 18 proceeds to step 1325 to calculate the corrected version of the static load on the subject wheel in the same manner as step 1125. Then, the correction section 18 proceeds to step 1330 to determine whether or not step 1305 and following steps have been executed for all of the wheels in the present control cycle. The correction section 18 repeats step 1305 and following steps until the determination at step 1330 becomes affirmative and terminates the vehicular characteristics correction process in the present control cycle when the determination at step 1330 becomes affirmative.

As described above, the wheels of the vehicle is divided into the two wheel groups, namely, the front wheel group and the rear wheel group. The front wheel group includes the two front part wheels, and the rear wheel group includes the two rear part wheels. In the vehicular characteristics correction process in the present embodiment, the brake force distribution control device 1 selects one of the four wheels one by one as the subject wheel, compares the slip amount of the subject wheel only with the slip amount of the other wheel in the wheel group to which the subject wheel belongs, and determines the load correction amounts based not on the relation with the wheels in the wheel group to which the subject wheel does not belong but on the relation with the other wheel in the wheel group to which the subject wheel belongs to. By separately determining the load correction amounts for the front wheel group and the load correction amounts for the rear wheel group, it is possible to properly control the brake forces generated at the front wheels and the rear wheels. Therefore, it is possible to maximize the braking performance of each of the four wheels while keeping proper attitude of the vehicle. In addition, it is possible to prevent the brake forces from being suppressed and accordingly prevent the stopping distance from becoming longer even if, for example, significant change occurs in how shipments are mounted to the vehicle.

### Fourteenth Embodiment

Hereinafter, a fourteenth embodiment of the present invention is described. In the present embodiment, following modification is given to the eleventh embodiment. In the modification, a reference slip amount for the front part wheels and a reference slip amount for the rear part wheels are determined. In addition, in the vehicular characteristics correction process, the correction amounts to be applied to the vehicular characteristics for the front right wheel and the front left wheel are set to a common value, and the correction amounts to be applied to the vehicular characteristics for the rear right wheel and the rear left wheel are set to a common value. It should be noted that a basic configuration of the brake force distribution control device 1 according to the present embodiment is identical with that of the eleventh embodiment. The only difference between the eleventh embodiment and the present embodiment is the vehicular characteristics correction process executed by vehicular characteristics correction section 18. Therefore, the vehicular characteristics correction process is described.

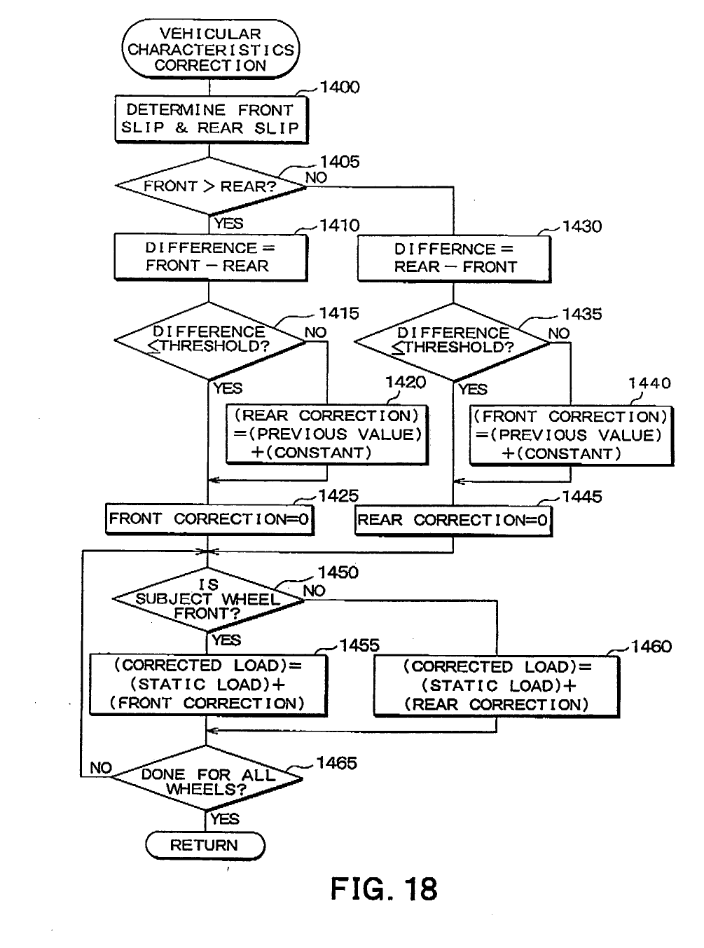

FIG. 18 is a flowchart showing a vehicular characteristics correction process for the wheels executed by the vehicular characteristics correction section 18 of the brake force distribution control device 1 according to the present embodiment. Based on a program stored in advance, the vehicular characteristics correction section 18 executes the vehicular characteristics correction process shown in FIG. 18 for the wheels at intervals of a predetermined control period.

On starting the vehicular characteristics correction process, the vehicular characteristics correction section 18 determines at step 1400 a reference front wheel slip amount and a reference rear wheel slip amount. The reference front wheel slip amount is a reference slip amount representing the states of slip at both of the front part wheels. The reference rear wheel slip amount is a reference slip amount representing the states of slip at both of the rear part wheels. Combination of the reference front wheel slip amount and the reference rear wheel slip amount can be any one of <1> to <5> described in the above description for step 400.

Then the correction section 18 proceeds to step 1405 to determine whether or not the reference front wheel slip amount is larger than the reference rear wheel slip amount. If the reference front wheel slip amount is larger than the reference rear wheel slip amount, the correction section 18 proceeds to step 1410. If the reference front wheel slip amount is smaller than the reference rear wheel slip amount, the correction section 18 proceeds to step 1430.

At step 1410, the correction section 18 calculates the difference (hereinafter referred to as a slip difference) between the reference front wheel slip amount and the reference rear wheel slip amount. More specifically, this slip difference is a result of the reference front wheel slip amount minus the reference rear wheel slip amount. Then the correction section 18 proceeds to step 1415 to determine whether or not this slip difference is equal to or smaller than a predetermined value (i.e. threshold). If the determination at step 1415 is negative, the correction section 18 proceeds to step 1420 in order to change a correction amount for a static load. At step 1420, the correction section 18 calculates a rear part correction amount at the present control cycle so that it becomes, as shown in the following equation, equal to the sum of a constant increase amount and a rear part correction amount at the previous control cycle.

(the rear part correction amount at the present control cycle)=(the rear part correction amount at the previous control cycle)+(the constant increase amount) (26)

After step 1420, the correction section 18 proceeds to step 1425.

If the determination at step 1415 is affirmative, the correction section 18 proceeds to step 1425 without modifying the rear part correction amount since there is no need for changing the correction amount for the static load. At step 1425, the correction section 18 assigns zero to a front part correction amount corresponding to the front part wheels having larger slip amounts than the rear part wheels. Then, the correction section 18 proceeds to step 1450.

At step 1430, the correction section 18 calculates the difference (hereinafter referred to as a slip difference) between the reference rear wheel slip amount and the reference front wheel slip amount. More specifically, this slip difference is a result of the reference rear wheel slip amount minus the reference front wheel slip amount. Then the correction section 18 proceeds to step 1435 to determine whether or not this slip difference is equal to or smaller than a predetermined value (i.e. threshold). If the determination at step 1435 is negative, the correction section 18 proceeds to step 1440 in order to change a correction amount for a static load. At step 1440, the correction section 18 calculates the front part correction amount at the present control cycle so that it becomes, as shown in the following equation, equal to the sum of a constant increase amount and a front part correction amount at the previous control cycle.

(the front part correction amount at the present control cycle)=(the front part correction amount at the previous control cycle)+(the constant increase amount) (27)

After step 1440, the correction section 18 proceeds to step 1445.

If the determination at step 1435 is affirmative, the correction section 18 proceeds to step 1445 without modifying the front part correction amount since there is no need for changing the correction amount for static load. At step 1445, the correction section 18 assigns zero to the rear part correction amount corresponding to the rear part wheels having larger slip amounts than the front part wheels. Then, the correction section 18 proceeds to step 1450.

At step 1450, the correction section 18 determines whether or not the subject wheel is a front part wheel. If the determination at step 1450 is affirmative, the correction section 18 proceeds to step 1455 to calculate the corrected version of the static load on the subject wheel based on the following equation (28). If the determination at step 1450 is negative, the correction section 18 proceeds to step 1460 to calculate the corrected version of the static load on the subject wheel based on the following equation (29).

The value of the front part correction amount shown in the equation (28) is identical with that calculated in step 1425 or step 1440. The value of the rear part correction amount shown in the equation (29) is identical with that calculated in step 1420 or step 1445.

(the corrected version of the static load)=(the static load on the subject wheel)+(the front part correction amount) (28)

(the corrected version of the static load)=(the static load on the subject wheel)+(the rear part correction amount) (29)

After step 1455 or step 1460, the correction section 18 finally proceeds to step 1465 to determine whether or not step 1450 and following steps have been executed for all of the wheels in the present control cycle. The correction section 18 repeats step 1450 and following steps until the determination at step 1465 becomes affirmative and terminates the vehicular characteristics correction process in the present control cycle when the determination at step 1465 becomes affirmative.

As described above, in the vehicular characteristics correction process, the brake force distribution control device 1 according to the present embodiment determines the reference front wheel slip amount for the front part wheels and the reference front wheel slip amount for the rear part wheels, sets the correction amounts to be applied to the vehicular characteristics for the front right wheel and the front left wheel to a common value, and sets the correction amounts to be applied to the vehicular characteristics for the rear right wheel and the rear left wheel to another common value. With this operation, the brake forces at the front and rear wheels are controlled so that they becomes the same even if the slip amount of either front or rear wheel becomes larger than the slip amount of an opposite part wheel. Therefore, it is possible to maximize the braking performance of each of the four wheels. In addition, it is possible to prevent the brake forces from being suppressed and accordingly prevent the stopping distance from becoming longer even if, for example, significant change occurs in how shipments are mounted to the vehicle.

### Fifteenth Embodiment

Hereinafter, a fifteenth embodiment of the present invention is described. In the present embodiment, following modification is given to the eleventh embodiment. In the modification, a reference slip amount for the right side wheels and a reference slip amount for the left side wheels are determined. In addition, in the vehicular characteristics correction process, the correction amounts to be applied to the vehicular characteristics for the front right wheel and the rear right wheel are set to a common value, and the correction amounts to be applied to the vehicular characteristics for the front left wheel and the rear left wheel are set to a common value. It should be noted that a basic configuration of the brake force distribution control device 1 according to the present embodiment is identical with that of the eleventh embodiment. The only difference between the eleventh embodiment and the present embodiment is the vehicular characteristics correction process executed by vehicular characteristics correction section 18. Therefore, the vehicular characteristics correction process is described.

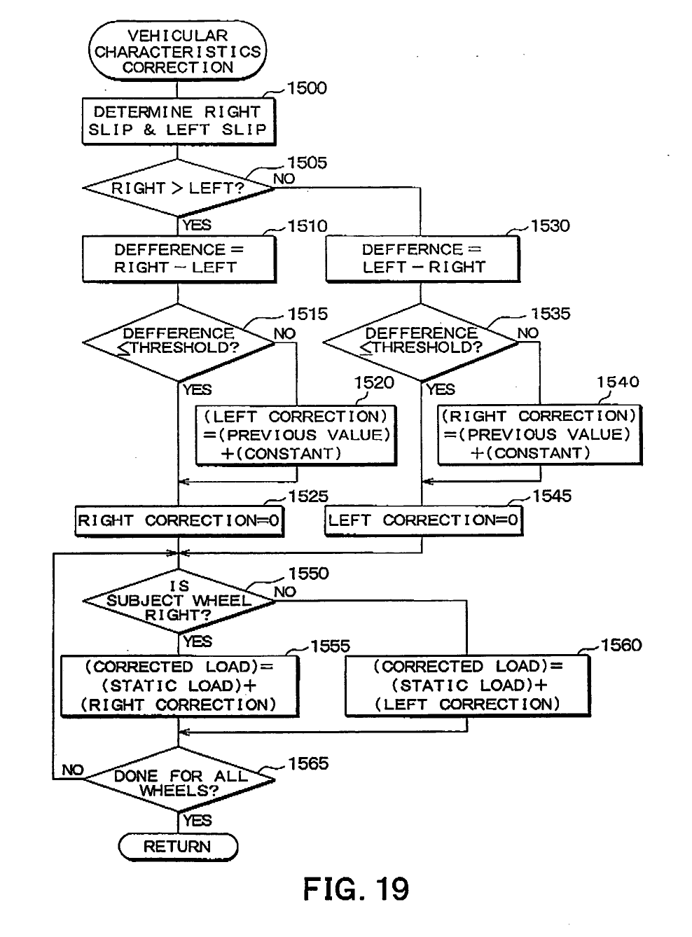

FIG. 19 is a flowchart showing a vehicular characteristics correction process for the wheels executed by the vehicular characteristics correction section 18 of the brake force distribution control device 1 according to the present embodiment. Based on a program stored in advance, the vehicular characteristics correction section 18 executes the vehicular characteristics correction process shown in FIG. 19 for the wheels at intervals of a predetermined control period.

On starting the vehicular characteristics correction process, the vehicular characteristics correction section 18 determines at step 1500 a reference right wheel slip amount and a reference left wheel slip amount. The reference right wheel slip amount is a reference slip amount representing the states of slip at both of the left side wheels. The reference left wheel slip amount is a reference slip amount representing the states of slip at both of the left side wheels. Combination of the reference right wheel slip amount and the reference left wheel slip amount can be any one of <1> to <5> described in the above description for step 500.

Then the correction section 18 proceeds to step 1505 to determine whether or not the reference right wheel slip amount is larger than the reference left wheel slip amount. If the reference right wheel slip amount is larger than the reference left wheel slip amount, the correction section 18 proceeds to step 1510. If the reference right wheel slip amount is smaller than the reference left wheel slip amount, the correction section 18 proceeds to step 1530.

At step 1510, the correction section 18 calculates the difference (hereinafter referred to as a slip difference) between the reference right wheel slip amount and the reference left wheel slip amount. More specifically, this slip difference is a result of the reference right wheel slip amount minus the reference left wheel slip amount. Then the correction section 18 proceeds to step 1515 to determine whether or not this slip difference is equal to or smaller than a predetermined value (i.e. threshold). If the determination at step 1515 is negative, the correction section 18 proceeds to step 1520 in order to change a correction amount for a static load. At step 1520, the correction section 18 calculates a left side correction amount at the present control cycle so that it becomes, as shown in the following equation, equal to the sum of a constant increase amount and a left side correction amount at the previous control cycle.

(the left side correction amount at the present control cycle)=(the left side correction amount at the previous control cycle)+(the constant increase amount) (30)

After step 1520, the correction section 18 proceeds to step 1525.

If the determination at step 1515 is affirmative, the correction section 18 proceeds to step 1525 without modifying the left side correction amount since there is no need for changing the correction amount for the static load. At step 1525, the correction section 18 assigns zero to a right side correction amount corresponding to the right side wheels having larger slip amounts than the left side wheels. Then, the correction section 18 proceeds to step 1550.

At step 1535, the correction section 18 calculates the difference (hereinafter referred to as a slip difference) between the reference left wheel slip amount and the reference right wheel slip amount. More specifically, this slip difference is a result of the reference left wheel slip amount minus the reference right wheel slip amount. Then the correction section 18 proceeds to step 1535 to determine whether or not this slip difference is equal to or smaller than a predetermined value (i.e. threshold). If the determination at step 1535 is negative, the correction section 18 proceeds to step 1540 in order to change a correction amount for a static load. At step 1540, the correction section 18 calculates the right side correction amount at the present control cycle so that it becomes, as shown in the following equation, equal to the sum of a constant increase amount and a right side correction amount at the previous control cycle.

(the right side correction amount at the present control cycle)=(the right side correction amount at the previous control cycle)+(the constant increase amount) (31)

After step 1540, the correction section 18 proceeds to step 1545.

If the determination at step 1535 is affirmative, the correction section 18 proceeds to step 1545 without modifying the right side correction amount since there is no need for changing the correction amount for static load. At step 1545, the correction section 18 assigns zero to the left side correction amount corresponding to the left side wheels having larger slip amounts than the right side wheels. Then, the correction section 18 proceeds to step 1550.

At step 1550, the correction section 18 determines whether or not the subject wheel is a right side wheel. If the determination at step 1550 is affirmative, the correction section 18 proceeds to step 1555 to calculate the corrected version of the static load on the subject wheel based on the following equation (32). If the determination at step 1550 is negative, the correction section 18 proceeds to step 1560 to calculate the corrected version of the static load on the subject wheel based on the following equation (33). The value of the right side correction amount shown in the equation (32) is identical with that calculated in step 1525 or step 1540. The value of the left side correction amount shown in the equation (33) is identical with that calculated in step 1520 or step 1545.

(the corrected version of the static load)=(the static load on the subject wheel)+(the right side correction amount) (32)

(the corrected version of the static load)=(the static load on the subject wheel)+(the left side correction amount) (33)

After step 1555 or step 1560, the correction section 18 finally proceeds to step 1565 to determine whether or not step 1550 and following steps have been executed for all of the wheels in the present control cycle. The correction section 18 repeats step 1550 and following steps until the determination at step 1565 becomes affirmative and terminates the vehicular characteristics correction process in the present control cycle when the determination at step 1565 becomes affirmative.

As described above, in the vehicular characteristics correction process, the brake force distribution control device 1 according to the present embodiment determines the reference right wheel slip amount for the right side wheels and the reference left wheel slip amount for the left side wheels, sets the correction amounts to be applied to the vehicular characteristics for the front right wheel and the rear right wheel to a common value, and sets the correction amounts to be applied to the vehicular characteristics for the front left wheel and the rear left wheel to another common value. Suppose that this operation is executed while the vehicle is, for example, turning. In this case, the brake forces at the right and left wheels are controlled so that they becomes the same even if the slip amount of either right or left wheel becomes larger than the slip amount of an opposite side wheel. Therefore, it is possible to maximize the braking performance of each of the four wheels while keeping proper attitude of the vehicle. In addition, it is possible to prevent the brake forces from being suppressed and accordingly prevent the stopping distance from becoming longer even if, for example, significant change occurs in how shipments are mounted to the vehicle.

### Other Embodiments

(1) In the above embodiments, once a slip difference between a subject wheel and a most-slipping wheel is determined to be larger than the predetermined value, the target brake force correction amount (or the load correction amount) for the subject wheel may be increased by the constant increase amount every control cycle until the ABS acts on all of the wheels. In this case, the termination condition for terminating the repeating increase of the target brake force correction amount (or the load correction amount) is that the ABS acts on all of the wheels. However, the termination condition may be that the ABS acts on one of the wheels, that the ABS acts on more than one of the wheels, or combination of the former two termination conditions.

(2) In the processes (more specifically steps 110, 210, 310, 425, 445, 525, 545, 610, 710, 810, 925, 945, 1025, 1045, 1110, 1210, 1310, 1425, 1445, 1525, and 1545) for assigning zero to a target brake force correction amount or a load correction amount for a wheel out of the scope of correction, the target brake force correction amount or the load correction amount may be decreased gradually until the correction amount becomes zero in order to suppress rapid decrease of the brake force. The brake force distribution control device 1 may determine, based on the value of the correction amount before starting decreasing to zero, whether or not to decrease gradually the correction amount.

(3) Sequence (i.e. order) of the front right, front left, rear right, and rear left wheels in the determination process in the above embodiments may vary.

(4) The vehicle may have four wheels in total as described in the above embodiments. However, the vehicle may have any number of wheels in total. For example, the vehicle may have two rear right wheels and two rear left wheels. In this case, the process described above may be applied to each of the two rear right wheels and the two rear left wheels.

(5) In the target brake force correction section 14, load estimation correction section 17, and vehicular characteristics correction section 18, the increase amount which is added to the target brake force correction amount (or the load correction amount) at the previous control cycle is a constant value. The increase amount for a subject wheel may be determined depending on the slip difference between the subject wheel and the most-slipping wheel.

(6) In the eleventh to fifteenth embodiments, correction is applied to the static load on a wheel. However, any other vehicular characteristics may be corrected. For example, the height of the center of gravity of the vehicle may be corrected based on the corrected loads on the wheels.

In addition, correction may be applied to the vehicular characteristics which influence the static loads of the wheels. In this case, the static loads are indirectly corrected, and it is therefore possible to attain the effect which is obtained by correcting directly the static loads. A static load on a wheel is equal to a load on the wheel when there is no longitudinal acceleration or lateral acceleration and change in the proportion of the wheel loads accordingly does not occur.

(7) In the case that the vehicle is moving slowly, accuracy of the detected slip amount is reduced. Therefore, the corrections described above may be prohibited in the case that the vehicle is moving at a speed smaller than a predetermined threshold speed.

In the case that the brake pedal is quickly pressed, the difference is likely to be generated between the increase rate of the brake force at the front part wheels and the increase rate of the brake force at the rear part wheels. In this case, the slip amount of a given wheel tends to become smaller than another wheel if the increase rate of the brake force at the given wheel is smaller than said another wheel. Therefore, the above correction process may be stopped when the brake pedal is pressed more quickly than a threshold.

(8) In the above embodiments, each of braking control periods starts when the driver starts operating the brake operation member, and ends when the driver stops operating the brake operation member. Each of the braking control periods includes a plurality of control cycles in each of which the brake force distribution control device 1 executes the correction process shown in FIG. 3, 4, 5, 6, 7, 9, 10, 11, 12, 13 15, 16, 17, 18, or 19 at every control cycles.

In addition to this, a convergence value of the target brake force correction amount (or the load correction amount) may be stored for each of the braking periods as change history. Each of the convergence values is a value of the target brake force correction amount (or the load correction amount) at the end of a braking control period. In this case, at the first control cycle in a braking control period, the correction amount in steps 120 220, 320, 420, 440, 520, 540, 620 720, 820, 920, 940, 1020, 1040, 1120 1220, 1320, 1420, 1440, 1520, and 1540 may be replaced with the mean value or the like of the stored convergence values at several preceding brake control periods.

(9) In the case that a wheel alternately becomes a wheel within the scope of correction and a wheel (such as the most-slipping wheel) out of the scope of correction, the brake force distribution control device 1 may determine that the correction process (e.g. the target brake force correction process, the load estimation correction process, and the vehicular characteristics correction process) will be completed soon and may gradually decrease the constant decrease amount or temporarily stop correcting the correction amount.

(10) When the correction of the correction amount is stopped or the change in the correction amount becomes sufficiently smaller, it is likely that the correction process is completed. In this case, the brake force distribution control device 1 may calculate new vehicular characteristics based on the values (such as the brake forces, the estimated loads, and the vehicular characteristics) after the completion of the correction process and the stored vehicular characteristics before correction. Then, the brake force distribution control device 1 may replace the original vehicular characteristics before correction with the new vehicular characteristics.

In this case, suppose that an event happens which influences vehicular characteristics. Such event includes one in which a person gets into the vehicle or gets out of the vehicle and one in which a shipment is put on the vehicle or put off from the vehicle. The brake force distribution control device 1 may detect occurrence of such event based on that a door of the vehicle is opened or closed, or based on that the trunk of the vehicle is opened or closed. When the brake force distribution control device 1 detects occurrence of such event, the brake force distribution control device 1 may restore the current vehicular characteristics to the original vehicular characteristics.

Otherwise, in the case that the mean value or the like of the convergence values is used as the correction amount at the first control cycle in a braking control period, the brake force distribution control device 1 may reset the convergence value to zero on detecting the occurrence of such event.

(11) Suppose that a load on a wheel can be estimated by any means other than that in the above embodiment. For example, suppose that a stroke of a suspension for a front wheel or a rear wheel is detected and thereby the load on the wheel is calculated. In this case, the detected stroke of a detected wheel may be directly used for calculation of the load of the wheel, and the load on the other wheels may be corrected based on the detected stroke of the detected wheel.

(12) In the above embodiments, a slip amount serves as an example of an amount related to as a wheel slip (hereinafter referred to a slip-related amount). The slip-related amount indicates a degree of wheel slip. However, the brake force distribution control device 1 operates well if the slip amount is replaced with any other slip-related amount such as a slip ratio.

(13) It should be noted that each step shown in the figures corresponds to a mean for executing the process in the step.

What is claimed is:

1. A brake force distribution control device which increases a brake force at a first wheel so that a slip amount of the first wheel becomes closer to a slip amount of a second wheel, wherein the slip amount of the second wheel is larger than the slip amount of the first wheel.

2. The brake force distribution control device according to claim 1, comprising:
a load estimation section for estimating wheel loads based on an acceleration of a body of a vehicle which is detected by a vehicular acceleration sensing section, each of the wheel loads being applied between one of wheels of the vehicle and the ground;
a target brake force calculation section for calculating target brake forces based on the estimated wheel loads, each of the target brake forces being a target value for a brake force at one of the wheels;
an output section for outputting, in order to generate the target brake forces, a signal indicating the target brake forces to a brake force generation device for controlling the brake forces at the wheels individually;
a slip-related amount calculating section for calculating slip-related amounts of the wheels based on wheel speeds of the wheels detected by a wheel speed sensing section, the slip-related amounts being related to slip amounts of the wheels; and
a target brake force correction section for determining a most-slipping wheel having the largest slip-related amount of the wheels and further for increasing each calculated target brake force of at least one of the wheels so that each slip-related amount of said at least one of the wheels becomes closer to the largest slip-related amount, said at least one of the wheels being at least one of wheels other than the most-slipping wheel.

3. The brake force distribution control device according to claim 2, wherein the target brake force correction section increases one of the target brake forces corresponding to a subject wheel belonging to the wheels if a difference between the largest slip-related amount and the slip-related amount of the subject wheel is larger than a predetermined value, wherein the subject wheel is a wheel subject to correction.

4. The brake force distribution control device according to claim 3, wherein the target brake force correction section:
determines a right most-slipping wheel having the largest slip-related amount of right side wheels of the vehicle;
increases one of the target brake forces corresponding to a right subject wheel belonging to the right side wheels if a difference between the slip-related amount corresponding to the right most-slipping wheel and the slip-related amount of the subject wheel is larger than a predetermined value, wherein the right subject wheel is a wheel subject to correction;
determines a left most-slipping wheel having the largest slip-related amount of left side wheels of the vehicle; and
increases one of the target brake forces corresponding to a left subject wheel belonging to the left side wheels if
a difference between the slip-related amount corresponding to the left most-slipping wheel and the slip-related amount of the subject wheel is larger than a predetermined value, wherein the left subject wheel is a wheel subject to correction.

5. The brake force distribution control device according to claim 3, wherein the target brake force correction section:
determines a front most-slipping wheel having the largest slip-related amount of front part wheels of the vehicle;
increases one of the target brake forces corresponding to a front subject wheel belonging to the front part wheels if a difference between the slip-related amount corresponding to the front most-slipping wheel and the slip-related amount of the subject wheel is larger than a predetermined value, wherein the front subject wheel is a wheel subject to correction;
determines a rear most-slipping wheel having the largest slip-related amount of rear part wheels of the vehicle; and
increases one of the target brake forces corresponding to a rear subject wheel belonging to the rear part wheels if a difference between the slip-related amount corresponding to the rear most-slipping wheel and the slip-related amount of the subject wheel is larger than a predetermined value, wherein the rear subject wheel is a wheel subject to correction.

6. The brake force distribution control device according to claim 1, comprising:
a load estimation section for estimating wheel loads based on an acceleration of a body of a vehicle which is detected by a vehicular acceleration sensing section, each of the wheel loads being applied between one of wheels of the vehicle and the ground;
a target brake force calculation section for calculating target brake forces based on the estimated wheel loads, each of the target brake forces being a target value for a brake force at one of the wheels;
an output section for outputting, in order to generate the target brake forces, a signal indicating the target brake forces to a brake force generation device for controlling the brake forces at the wheels individually;
a slip-related amount calculating section for calculating slip-related amounts of the wheels based on wheel speeds of the wheels detected by a wheel speed sensing section, the slip-related amounts being related to slip amounts of the wheels; and
a load estimation correction section for determining a most-slipping wheel having the largest slip-related amount of the wheels and further for correcting each estimated wheel load on at least one of the wheels so as to increase each calculated target brake force of said at least one of the wheels so that each slip-related amount of said at least one of the wheels becomes closer to the largest slip-related amount, said at least one of the wheels being at least one of wheels other than the most-slipping wheel.

7. The brake force distribution control device according to claim 6, wherein the load estimation correction section increases one of the estimated wheel loads corresponding to a subject wheel belonging to the wheels if a difference between the largest slip-related amount and the slip-related amount of the subject wheel is larger than a predetermined value, wherein the subject wheel is a wheel subject to correction.

8. The brake force distribution control device according to claim 7, wherein the load estimation correction section:
determines a right most-slipping wheel having the largest slip-related amount of right side wheel of the vehicle;
increases one of the estimated wheel loads corresponding to a right subject wheel belonging to the right side wheels if a difference between the slip-related amount corresponding to the right most-slipping wheel and the slip-related amount of the subject wheel is larger than a predetermined value, wherein the right subject wheel is a wheel subject to correction;
determines a left most-slipping wheel having the largest slip-related amount of left side wheels of the vehicle; and
increases one of the estimated wheel loads corresponding to a left subject wheel belonging to the left side wheels if a difference between the slip-related amount corresponding to the left most-slipping wheel and the slip-related amount of the subject wheel is larger than a predetermined value, wherein the left subject wheel is a wheel subject to correction.

9. The brake force distribution control device according to claim 7, wherein the load estimation correction section:
determines a front most-slipping wheel having the largest slip-related amount of front part wheels of the vehicle;
increases one of the estimated wheel loads corresponding to a front subject wheel belonging to the front part wheels if a difference between the slip-related amount corresponding to the front most-slipping wheel and the slip-related amount of the subject wheel is larger than a predetermined value, wherein the front subject wheel is a wheel subject to correction;
determines a rear most-slipping wheel having the largest slip-related amount of rear part wheels of the vehicle; and
increases one of the estimated wheel loads corresponding to a rear subject wheel belonging to the rear part wheels if a difference between the slip-related amount corresponding to the rear most-slipping wheel and the slip-related amount of the subject wheel is larger than a predetermined value, wherein the rear subject wheel is a wheel subject to correction.

10. The brake force distribution control device according to claim 1, comprising:
a load estimation section for estimating wheel loads based on predetermined vehicular characteristics and on an acceleration of a body of a vehicle which is detected by a vehicular acceleration sensing section, each of the wheel loads being applied between one of wheels of the vehicle and the ground;
a target brake force calculation section for calculating target brake forces based on the estimated wheel loads, each of the target brake forces being a target value for a brake force at one of the wheels;
an output section for outputting, in order to generate the target brake forces, a signal indicating the target brake forces to a brake force generation device for controlling the brake forces at the wheels individually;
a slip-related amount calculating section for calculating slip-related amounts of the wheels based on wheel speeds of the wheels detected by a wheel speed sensing section, the slip-related amounts being related to slip amounts of the wheels; and
a vehicular characteristics correction section for determining a most-slipping wheel having the largest slip-related amount of the wheels and further for correcting each vehicular characteristic used to estimate each estimated wheel load on at least one of the wheels so as to increase each calculated target brake force of said at least one of the wheels so that each slip-related amount of said at least one of the wheels becomes closer to the largest slip-related amount, said at least one of the wheels being at least one of wheels other than the most-slipping wheel.

11. The brake force distribution control device according to claim 10, wherein the vehicular characteristics correction section corrects one of the vehicular characteristics corresponding to a subject wheel belonging to the wheels if a difference between the largest slip-related amount and the slip-related amount of the subject wheel is larger than a predetermined value, wherein the subject wheel is a wheel subject to correction.

12. The brake force distribution control device according to claim 11, wherein the vehicular characteristics correction section:
determines a right most-slipping wheel having the largest slip-related amount of right side wheels of the vehicle;
corrects one of the vehicular characteristics corresponding to a right subject wheel belonging to the right side wheels if a difference between the slip-related amount corresponding to the right most-slipping wheel and the slip-related amount of the subject wheel is larger than a predetermined value, wherein the right subject wheel is a wheel subject to correction;
determines a left most-slipping wheel having the largest slip-related amount of left side wheels of the vehicle; and
corrects one of the vehicular characteristics corresponding to a left subject wheel belonging to the left side wheels if a difference between the slip-related amount corresponding to the left most-slipping wheel and the slip-related amount of the subject wheel is larger than a predetermined value, wherein the left subject wheel is a wheel subject to correction.

13. The brake force distribution control device according to claim 11, wherein the vehicular characteristics correction section:
determines a front most-slipping wheel having the largest slip-related amount of front part wheels of the vehicle;
corrects one of the vehicular characteristics corresponding to a front subject wheel belonging to the front part wheels if a difference between the slip-related amount corresponding to the front most-slipping wheel and the slip-related amount of the subject wheel is larger than a predetermined value, wherein the front subject wheel is a wheel subject to correction;
determines a rear most-slipping wheel having the largest slip-related amount of rear part wheels of the vehicle; and
corrects one of the vehicular characteristics corresponding to a rear subject wheel belonging to the rear part wheels if a difference between the slip-related amount corresponding to the rear most-slipping wheel and the slip-related amount of the subject wheel is larger than a predetermined value, wherein the rear subject wheel is a wheel subject to correction.
